(19) United States
(12) Patent Application Publication
(10) Pub. No.: US 2016/0014159 A1
(43) Pub. Date: Jan. 14, 2016

(54) SEPARATED SECURITY MANAGEMENT

(71) Applicants: Sven Schrecker, San Marcos, CA (US); Charles Speicher, Waxhaw, NC (US); John Reynolds, Santa Clara, CA (US); Aric Shipley, Livermore, CA (US); Arlen Baker, Scottsdale, AZ (US)

(72) Inventors: Sven Schrecker, San Marcos, CA (US); Charles Speicher, Waxhaw, NC (US); John Reynolds, Santa Clara, CA (US); Aric Shipley, Livermore, CA (US); Arlen Baker, Scottsdale, AZ (US)

(21) Appl. No.: 14/583,445

(22) Filed: Dec. 26, 2014

Related U.S. Application Data
(60) Provisional application No. 62/023,035, filed on Jul. 10, 2014.
(60) Provisional application No. 62/023,080, filed on Jul. 10, 2014.

(51) Int. Cl. H04L 29/06

(52) U.S. Cl. CPC H04L 63/20

(57) ABSTRACT

A plurality of devices in a system are identified, each device having an operational context. One of a plurality of agents are identified for each of the plurality of devices, which correspond to the device. Data is received from the plurality of agents that describes security attributes of the plurality of devices. Policy data is sent to each of the plurality of agents to cause a set of security policies to be applied to the plurality of devices through the security management instances. Each of the plurality of agents can be provided in a respective security management instance separate from the operational context.

This patent application claims the benefit of priority under 35 U.S.C. §120 of U.S. Provisional Patent Application Ser. No. 62/023,035, filed Jul. 10, 2014, entitled “SEPARATED APPLICATION SECURITY MANAGEMENT” and U.S. Provisional Patent Application Ser. No. 62/023,080, filed Jul. 10, 2014, entitled “SEPARATED APPLICATION SECURITY MANAGEMENT”, which are both expressly incorporated herein by reference in their entirety.

### TECHNICAL FIELD

This disclosure relates in general to the field of computer security and, more particularly, to enhancing security for legacy systems.

### BACKGROUND

The Internet has enabled interconnection of different computer networks all over the world. The ability to effectively protect and maintain stable computers and systems, however, presents a significant obstacle for component manufacturers, system designers, and network operators. Indeed, each day thousands of new threats, vulnerabilities, and malware are identified that have the potential of damaging and compromising the security of computer systems throughout the world. Antivirus, antispyware, and other antimalware products and solutions have been developed. Some traditional antimalware products employ a host-centric approach in which the bulk of the functionality of the antimalware tool is installed onto the host, with the antimalware tool occasionally downloading an update of remediation tools, virus definition files, and other content to keep the antimalware tool abreast of newly discovered malware and other developments. The antimalware tool can then screen objects, processes, downloads, and other events on the host machine to determine whether malware exists on the host, per the content received from the updater, as well as attempt to remediate the malware using functionality available at the host-based antimalware tool. The updater can catalog various malware and code that could potentially be malware and can use this information to provide content describing malware known to the updater.

### BRIEF DESCRIPTION OF THE DRAWINGS

FIG. 1 illustrates an embodiment of a physical system.

FIG. 2 illustrates an embodiment of a physical system including physical equipment and information management systems.

FIG. 3A illustrates an embodiment of an example system.

FIG. 3B illustrates the example system of FIG. 3A secured using a separated security architecture.

FIG. 4 illustrates an embodiment of a system including a secured network gateway, a secured platform, and a security management service.

FIG. 5 illustrates an embodiment of an example secured platform including a security management instance and application instance.

FIG. 6 illustrates an embodiment of an example secured network gateway including a security management instance.

FIG. 7 illustrates another embodiment of an example secured network gateway including a security management instance.

FIG. 8 illustrates a secure tunnel established by a secured network gateway.

FIG. 9 illustrates example trusted transaction spaces.

FIG. 10 illustrates a plurality of systems utilizing a security management instance.

FIG. 11 illustrates an embodiment of a system including an example operational management system and a security management system

FIGS. 12A-12B are flowcharts illustrating example techniques to provide security to an asset.

FIG. 13 is a block is a block diagram of an exemplary processor in accordance with one embodiment; and

FIG. 14 is a block diagram of an exemplary computing system in accordance with one embodiment.

Like reference numbers and designations in the various drawings indicate like elements.

### DETAILED DESCRIPTION OF EXAMPLE EMBODIMENTS

A system made up of a diverse and expansive array of subcomponents or subsystems may be difficult to update in a unified way, given the variety of vendors and component types in the system. As an example, an industrial or power plant can be composed of multiple different tools, transport devices, switches, valves, and sensors. The varied components can be sourced from a variety of vendors. Further, some of these components may have corresponding computing resources to assist in control and monitoring of the components. The computing resources used to assist these components can be just as diverse as the components they control, with the computing resources provided by various vendors, hosted on various computing devices, and executed on operating systems. Further, while some devices may be capable of receiving signals from other devices, communications capabilities of such devices may be limited, for instance, to certain limited-use protocols, with constrained partner devices, etc. Additionally, it may be desirable to interconnect a varied grouping of computing resources in a network to thereby interconnect the components controlled or monitored by the computing resources. In some cases, centralized computing systems can be provided to manage interconnected components through the computer resources controlling and/or monitoring the components.

The interconnectedness of computing resources controlling or monitoring components in a system can reflect dependencies of the components on other components in the system. For instance, two tools in a system can be connected by a transport, such as a pipe, conveyor, or other mechanism. Additional mechanisms (e.g., valves) can be used to control the flow between the tools on the transport. Interdependencies between components can make it difficult (and expensive) to replace or update any one of the components without potentially jeopardizing other components dependent on the component, as well as corresponding computing resources used to facilitate control or monitoring of the components, as well as communications between components.

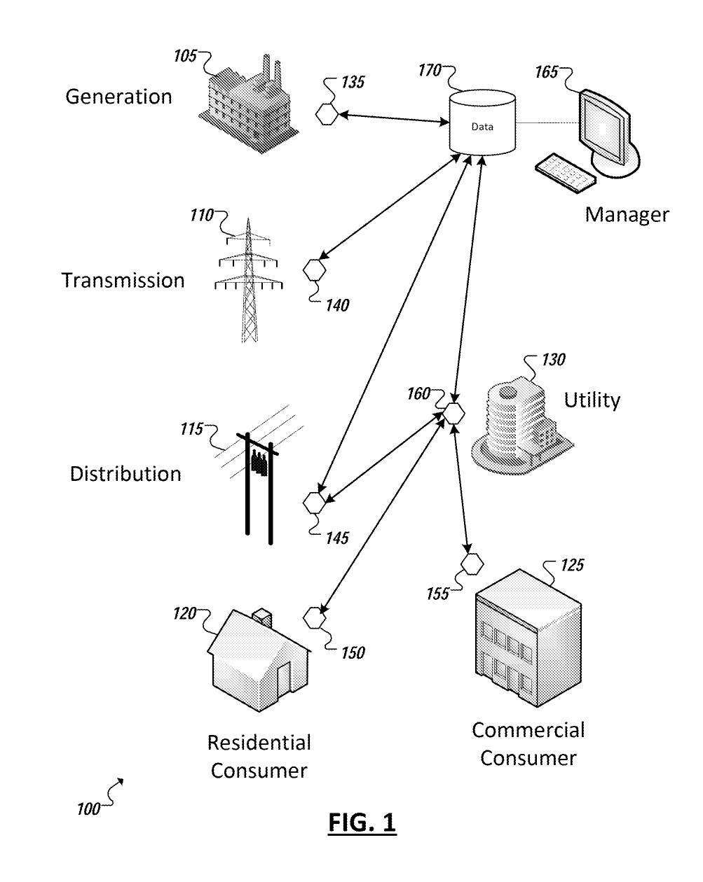

FIG. 1 is simplified block diagram illustrating a simplified representation of a system 100 that includes varied components, at least some of which are controlled and/or monitored by computing devices. In this example, a portion of a power grid is illustrated. For instance, power generation and delivery can involve multiple stages or domains. For instance, one or more power plants (e.g., 105) can be provided in a power generation domain. Transmission infrastructure (e.g., 110) can be provided to transport electricity generated at the plants over long distances and over one or more substations. A distribution network (e.g., 115) can be provided to provide stepped-down voltage to customer meter sockets at multiple customer premises, including residential consumers (e.g., 120) and commercial consumers (e.g., 125) and so on. Other stages and equipment can be provided to generate and deliver the electric power to consumers. A number of different types of equipment can be provided from potentially multiple different manufacturers and vendors across the system 100. Further facilities can be included in the system, such as, in this case, an electric utility organization 130 that can manage flow of electricity within the system and match the supply of electricity with the demand, for instance, by coordinating with other utilities to buy and sell electricity. To monitor and control performance of the system, various computer-based controllers or sensors (e.g., 135, 140, 145, 150, 155, 160) can be provided to monitor and control individual equipment across the system 100. Further, to facilitate the sophisticated interchange of information within the system to control delivery of electricity in accordance with detected demand, and other use cases, computer controllers (e.g., 135, 140, 145, 150, 155, 160) can communicate or otherwise make their data available to other computer controllers in the system (e.g., over one or more networks). For instance, a computer-implemented sensor 150 at a residential consumer 120 can communicate data to a computing device (e.g., 160) of a utility company selling electricity to the consumer, for instance, to identify demand as measured by the consumer meter (and multiple consumer meters across the network).

In addition to facilitating communication between devices used to automate monitoring and control of a system, one or more centralized management systems (e.g., 165) can be provided to leverage the information collected (or collectable) from the operation of the various computing devices implemented in the system 100. For instance, data can be collected in a data store 170, which can be mined and processed by the management system 165 to identify opportunities to further automate and optimize the interaction of the diverse components in the system.

In addition to complex, defined systems, such as infrastructure, plants, and similar systems, new ad-hoc systems and networks are emerging as more and more products and equipment evolve to communicate, through computer-implemented mechanisms, with other computing devices (and products having network communication capabilities). For instance, the phenomenon of the “internet of things” includes networks built from sensors and communication modules integrated in or attached to “things” such as equipment, toys, tools, and even living things (e.g., plants, animals, humans). Systems including connected “things” share many of the features and issues of complex and diverse connected systems, such as a varied group of vendors, various host computing devices, operating systems, software applications, and technologies. Enabling communication between such diverse devices can be problematic. Maintaining consistent standards, including security standards and policies, can be even more of a challenge.

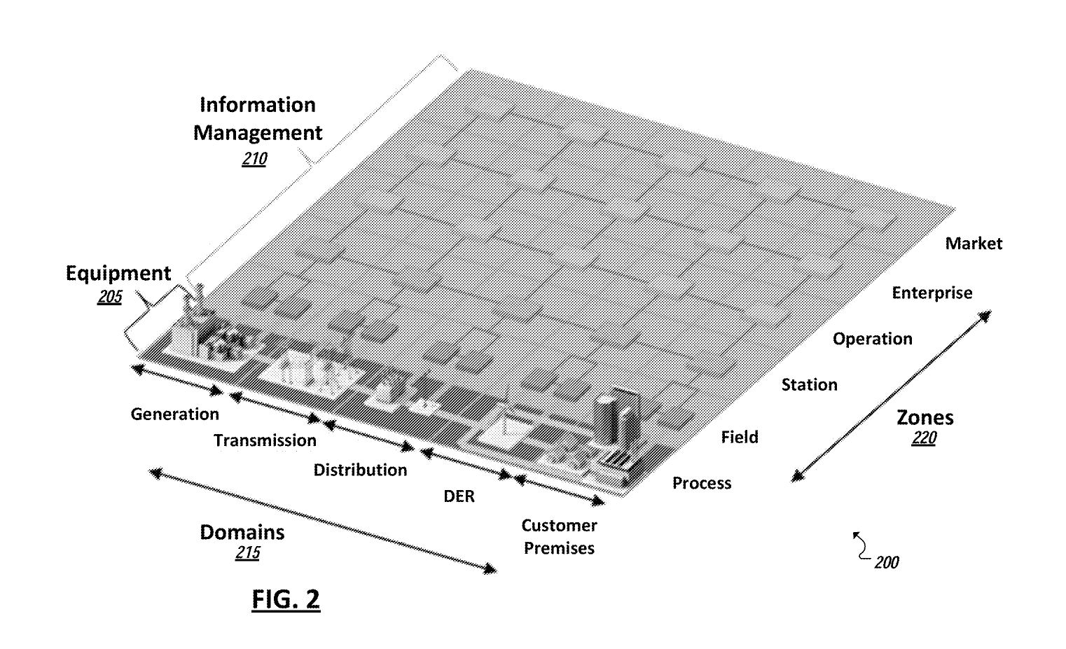

FIG. 2 illustrates another representation 200 of a complex system, such as a power grid. This representation 200 illustrates the dichotomy of physical equipment, apparatus, and things (e.g., 205) and the information management tools 210 (e.g., provided by one or more supporting computers) to connect the equipment 205 to the information management facilities of other equipment, including outside networks, such as the Internet. The diversity of the equipment 205 and computer information management tools 210 is reflected through the various domains 215 served by the system. Still further complexity is added by the various zones of information management, resulting, in some cases, in several layers of computing tools and components used to monitor and/control any one component.

The evolution toward “smart” and connected equipment, while providing substantial gains in efficiency and control, introducing and integrating computer systems (including network-connected computer systems) into equipment of systems can also introduce the myriad of vulnerabilities and threats affecting traditional computing devices and networks to equipment and systems not previously exposed to such threats. These vulnerabilities can be particularly problematic when the computer controls and networking capabilities open up critical equipment, systems, and infrastructure to abuse. However, given the diverse array of equipment employed in these systems and the similarly diverse computer controls and applications developed for such equipment, outfitting such a system with security capabilities that coherently and consistently safeguard the system can be difficult to implement. Further, given the interconnectedness of the systems, failure to safeguard one component can potentially open other components, or the system as a whole, to vulnerabilities.

As noted above, proprietary and custom software-based controls have been implemented in various devices, machines, controllers, and other equipment of various physical systems to improve the overall functionality and reliability of these systems. Many of the (software) applications developed to control and provide functionality for equipment in the system (e.g., pumps, transformers, power stations, valves, sensors, controllers, etc.) can make use of network connections to allow the applications (and computers hosting the applications) to send and receive data to and from other devices, as well as to and from “cloud”-based services, using private and/or public networks. In expansive physical systems (e.g., the electrical grid or a large Internet of Things network) the system components and their respective applications can be widely dispersed, provided (and managed) by a myriad of different vendors and owners, and can utilize a variety of different computing platforms and operating systems, (including legacy and proprietary OSes), among other challenges. Further, some equipment that would be useful to interconnect to other equipment, may be constrained in their ability to communicate with other devices and supporting computing devices. Additionally, reliability and availability are often at a premium for widespread architectures and systems (e.g., a community cannot afford prolonged or ongoing outages in electrical or water infrastructure), and there is hesitancy within these industries for dramatic retrofitting of applications that already “work” and that would require retraining of specialized employees, periods of fault maintenance in the new software patches, etc., to say nothing of such retrofitting being prohibitively expensive to achieve across systems over the short term. Traditionally, security solutions for these software controls (or “applications”) have also often been custom-developed on a component- and application-specific basis, leading to a series of one-off (and in many cases incompatible) solutions within a far-reaching and diverse, yet interdependent, system.

In some implementations, a flexible, distributable security platform can be provided that enables a consistent platform to build security solutions upon for potentially any of a diverse array of software solutions, including custom or one-off software controls, applications of proprietary operating systems, etc. Such a platform can allow the flexibility and interoperability to facilitate widespread deployment and support of consistent security management and policy enforcement without requiring the reworking of underlying applications that are relied upon for continuous delivery of the business services provided by their physical systems.

In one example, a framework leverages principles of separation to separate security management of the component sub-systems from operational management of the component sub-systems, the operational management concerned with the purpose, operation, and interactions of the sub-systems kernel. The framework can further normalize security management by providing a platform through which a diverse array of sub-systems can be secured and uniform security policies enforced without interfering with the underlying operational context of the subsystems. Such a framework can provide for system-wide security through: 1) embedded security at each endpoint equipment computer application; 2) securing communication between endpoint components and other devices; and 3) providing consistent security policy management and security event monitoring through backend security services (e.g., such as provided by centralized security management platform and/or other backend information technology (IT) security solutions).

Such a framework can be implemented to outfit existing operational functionality of subsystem (e.g., as embodied by applications or other software) with security functionality without modifying (or making only very minor modifications to) the operational context. Such a platform separates the functional (e.g., business-related) aspects of the application (or application instance(s)) from the management and security aspects (the security management instance). The security management instance wraps the operational, or application, instance in security features provided through the security management instance. Therefore, the security management instance effectively sits below the application instance(s) and can intercept actions coming from the application instance's virtual components before they are implemented by the physical hardware.

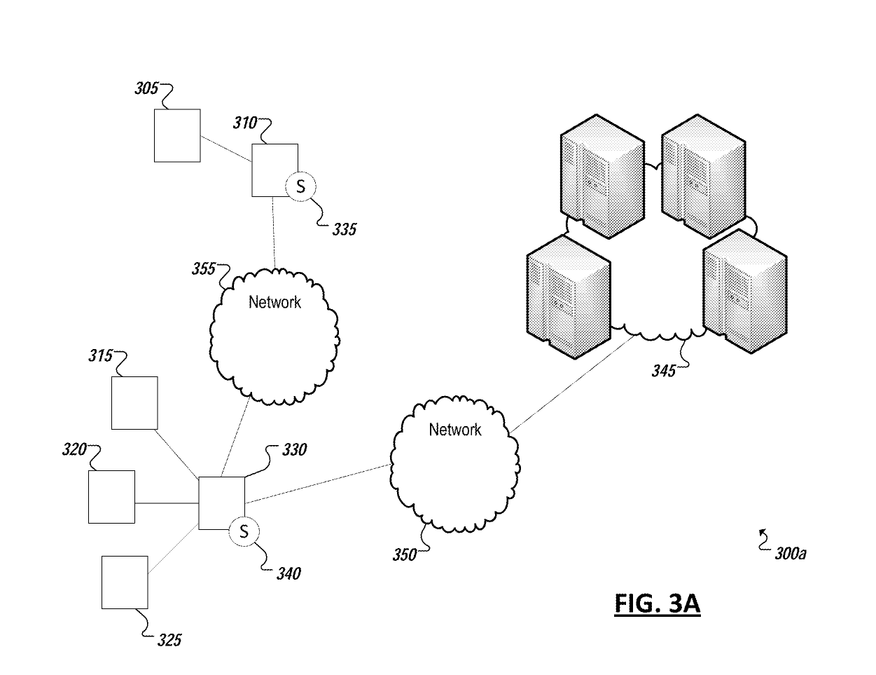

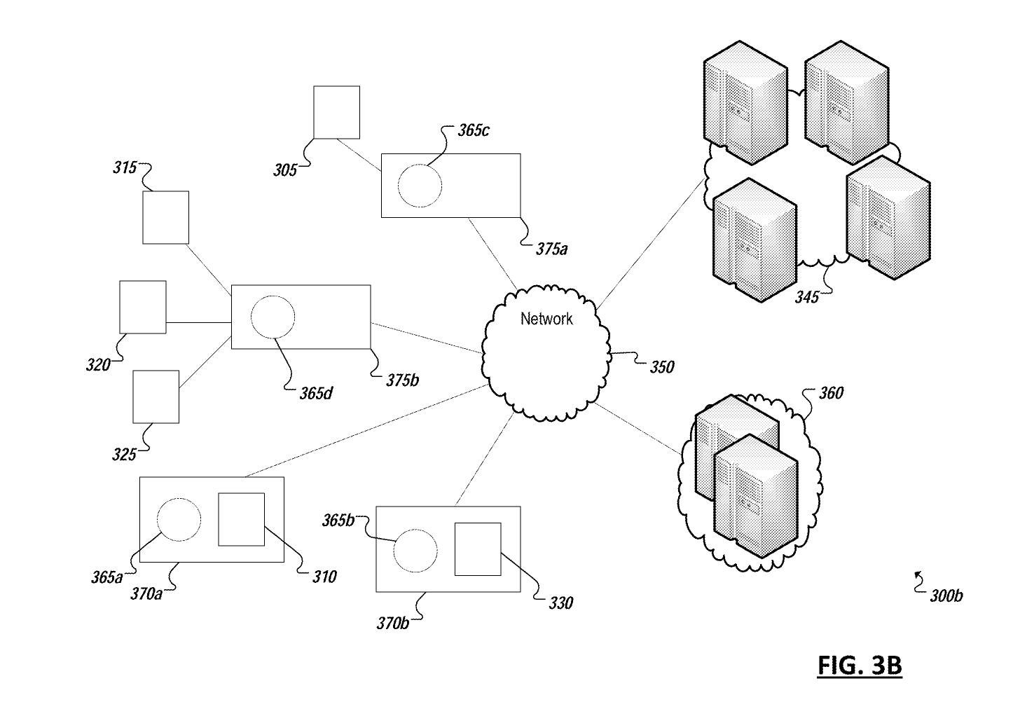

Turning to FIG. 3A, a simplified block diagram 300a is shown illustrating a first version of an example system. In this particular example, a system can include multiple different devices 305, 310, 315, 320, 325, 330, all of which have at least some computing functionality and/or communications capabilities. However, some devices may have more computing power than others. For instance, some of the devices (e.g., 305, 315, 320, 325) can be “dumb” in the sense that they are configured to only perform limited computing tasks and understand (or communicate) limited signals. For instance, endpoint devices 305, 315, 320, 325 may be computing logic to receive instructions from a centralized controller to perform an action and cause a physical component or equipment to take that action. For instance, endpoint devices may represent computing logic provided at a pump, manufacturing tool, traffic signal, temperature sensor, or other tool that causes the tool to perform a specific, corresponding task, such as toggle states, adjust up/down, etc. in response to a signal from a controller (e.g., 310, 330). These dumb devices 305, 315, 320, 325 may additionally or alternatively possess functionality for sending information to a “smart” controller or monitor (e.g., 310, 330), such as a notification that a door or valve is open, an indication of a value measured or sensed by the dumb device (e.g., pressure, temperature, weight, etc.), or other such task.

A dumb device may not possess an operating system, software, or other higher-level or more generally purpose computing logic and capabilities. Accordingly, in such example, it may be impossible to install or deploy traditional network or computing security tools on the devices. However, in many cases, the dumb devices may represent the direct interface with a piece of equipment or machinery that is particularly critical or sensitive (e.g., a pump controller of a nuclear reactor, a physical security sensor, an emergency shutoff control, etc.). Accordingly, dumb devices may be attractive targets to malicious actors, while at the same time being difficult to protect.

In the example of FIG. 3A, dumb devices may be paired with smart (or smarter) devices that can provide more intelligent control to the dumb devices and serve as the central control or monitor of multiple dumb devices (as with device 330). A smart device, in some instances, may possess more sophisticated and powerful computer processing capabilities, as well as an operating system, applications, and software programs that enable the device's functionality. As a result of these additional computing capabilities, security solutions (e.g., 335, 340) may developed, such as anti-malware, intrusion detection, intrusion prevention, communication filtering, firewall, or other security tools, that can be deployed on the smart device. This notwithstanding, the particular configuration of a smart device may sometimes involve crafting a proprietary or custom solution compatible with the particular smart device, which itself may be proprietary or custom-engineered system. Smart devices (e.g., 310, 330) may also include network adaptors or other functionality that allow the smart devices to engage in more sophisticated communications sessions, such as transactions with remote services and systems (e.g., 345) over one or more networks (e.g., 350) including private and public networks, including the internet. Smart devices may also be configured to communicate and transact with other smart devices in the system (e.g., over a private network 355). While this interconnectedness may facilitate greater control and management of the system and its components, the interconnectedness may also introduce network-based vulnerabilities to the system that were hitherto irrelevant. Indeed, the design and deployment of the operational functionality and context of a system may predate computing networks, computer-aided management, monitoring, and control, loT paradigms, and other principles driving modern device “intelligence.”

As can be appreciated by the example of FIG. 3A, through the interconnections between devices 305, 310, 315, 320, 325, 330, network-based threats or vulnerabilities on one device (e.g., 330) can effectively threaten other devices connected to it (e.g., 315, 320, 325). Further, certain policies may be desired within the network of devices, such as governmental, enterprise, or other policies, including security policies. However, not every device 305, 310, 315, 320, 325, 330 may be equipped to enforce these policies. Indeed, some devices (e.g., 305, 315, 320, 325) may have no modern security features implemented on them. Further, in the cases when security tools are provisioned on some of the devices (e.g., 310, 330), these security tools may possess different, uneven, and even incompatible security functionality. This can result in uneven or inconsistent enforcement of policies, or the adoption of inadequate policies tailored to cater to the lower common denominator within the network. While ad hoc security enhancements can be developed and deployed on a piecemeal basis to the various computing devices, the size, technological diversity, and ownership of the network may make the end-to-end securing of the network prohibitively difficult.

FIG. 3B shows a simplified block diagram 300b illustrating an example implementation of a platform to preserve an operational context while adding a separate security context to an existing system (e.g., the system of FIG. 3A). For instance, a security management instance can be provided that includes a common set of security tools and functionality. An instance of the security management instance can be deployed to correspond to each of the devices (e.g., 305, 310, 315, 320, 325, 330) in the system of FIG. 3A. The common set of security tools can enable a common set of policies to be defined and enforced uniformly across the diverse set of devices, including both dumb and smart devices. In some cases, the set of security tools can represent and facilitate a minimum baseline of security. In some cases, the core security management functionality of any given security management instance can be extended to include additional security tools and support other policies that are specific or unique to a given application, guest operating system, or equipment corresponding to the device (e.g., 305, 310, 315, 320, 325, 330).

Further, each security management instance can include a management agent, or agent, that can communicate information derived through the security tools of the security management instance to a backend security management service system 360 configured to analyze security information obtained from various agents (including agents deployed on different systems), and provide updated and/or dynamic security analysis and support, including situational and behavioral analysis, policy updates, among other features and services. Further, the security management service 360 can communicate (e.g., over network 350) with the agents to push policies and policy updates to the security management instances, such that the security tools can appropriately enforce the policy at the device. As an example, trusted execution environments can be defined to enable communications (as well as particular types of communication) between devices that are to communicate within an operational context, while restricting communications outside of this operation context. In other examples, the security management service 360 can consume data delivered by one or more agents to determine emerging threats in a system and push policy updates to the security management instances of vulnerable devices, among other uses and examples.

In the particular example of FIG. 3B, security management instances 365a-d are deployed to provide a normalized security context to a set of diverse devices in a system. The security management instances 365a-d can be deployed in a variety of ways. For instance, for smart devices 310, 330, the applications providing the operational context of the smart devices can be virtualized or containerized in platforms 370a, 370b. Each platform 370a, 370b can include a respective security management instance 365a, 365b that is hardened, at least in part, through hardware-based security (i.e., through hardware-based features implemented on the platforms). The security management instance 365a, 365b can wrap, or sit below, the operational functionality of each device (represented by blocks 310, 330 in FIG. 3B) to effectively build a wall of security around the operational functionality.

Other devices, such as dumb devices, may not possess the base level of computing functionality of power to allow these devices to be virtualized or containerized on a platform (e.g., 370a, 370b). However, these devices can be protected by connecting the devices (e.g., 305, 315, 320, 325) to gateway devices 375a, 375b, each provisioned with a respective security management instance 365c, 365d). The gateway devices 375a, 375b, in addition to providing enhanced security features, can also enhance the communication capabilities of the dumb devices (e.g., 305, 315, 320, 325). For instance, the gateway devices 375a, 375b can tunnel the native signals and messages of the dumb devices (e.g., 305, 315, 320, 325) over more sophisticated protocols that can open the door for additional security protections to be applied to communications involving the dumb devices. Further, with agents provided on each of the security management instances 365a-d, a normalized interface is provided between each device and backend security service 360, allowing information to be gathered regarding each device's (e.g., 305, 310, 315, 320, 325, 330) activities in the network and for coherent and uniform policies to be determined and applied across the system, to each of the devices 305, 310, 315, 320, 325, 330 through the respective security instances (e.g., 365a-d).

In the example of FIG. 3B, an architecture is deployed utilizing security management instances that are separate from, and preserve the native operational contexts of, the sub-systems, or devices, they protect. Through such an architecture, security of an existing application can be supplemented/enhanced without touching the application's own functionality or code. Traditional solutions, on the other hand, are typically developed specifically for a particular application and plug into or involve a modification of the application itself, potentially changing the workflow and functionality of the application. Further, because traditional security solutions and enhancements are often one-off, retrofitting components (and their respective applications) across a system involves engineering, in parallel, multiple, specific security solutions, patches, etc. for each individual application in the system. In systems where the exploitation of even a single component (e.g., a nuclear pump controller, or other essential component) can be catastrophic, providing a uniform, flexible platform as a security solution that is compatible across platforms and components can enable widespread and consistent deployment of security enhancements across a platform.

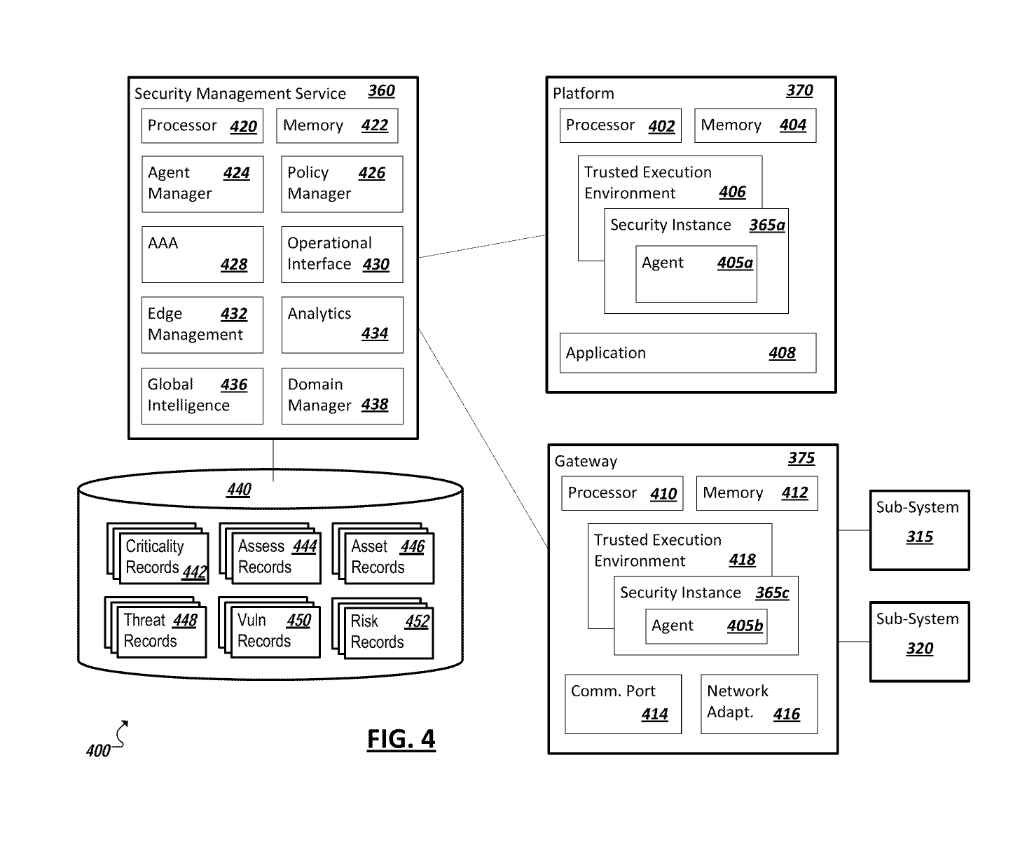

Turning to FIG. 4, a simplified block diagram 400 is shown illustrating one example implementations of a platform 370, a gateway 375, and security management service (or manager) 360, such as utilized in the example of FIG. 3B. In this particular example, a platform 370 can include one or more processor devices 402 and one or more memory elements 404 that can be used to implement one or more hardware- and/or software-based components, including a security management instance 365a (or, simply, “security management instance”). The security management instance 365 can include an instance of an agent 405a for use in interfacing with a backend security management service 360. The agent 405a can monitor operation of a set of security tools and logic incorporated in the security management instance 365a. Further, the agent 405a can provide information to the security tools to guide their operations, for instance, in correspondence with one or more policies provided to the agent 405a by the security management service 360. The agent 405a can also report real-time events detected by one or more of the security tools, to alert the security management service of conditions, and evolving threats, at the platform that can affect the applications 408 protected by the security management instance. The one or more applications 408 can embody the operational context of a subsystem.

The subsystem applications can be instantiated on the platform 370 of a “security management instance” and can leverage hardened security features of the platform. For instance, hardware-based security can be provided through one or more of the processor devices 402 to realize one or more trusted execution environments 406 within the platform. Trusted execution environments 406 can be executed using secure hardware components, such as components separated from operating systems of either the security management instance and/or the application. Trusted execution environments 406 can containerize one or more security tools (e.g., encryption and embedded identity utilities of the security management instance), all or a portion of the security management instance 365a, utilities used to facilitate communication between the application(s) 408 and security management instance 365a, as well as all or a portion of the application(s) 408.

For other subsystems (e.g., 315, 320), a secured gateway 375 can be provided to provide a security management instance 365c that can secure the operational functionality of the sub-systems 315, 320. The secured gateway 375, as with the platform 370, can include one or more processor devices 410 and memory 412 to execute a security management instance 365c and corresponding agent 405b within the gateway, together with other gateway logic, including communication ports 414 and network adapters 416, among other examples. The processors 410 (and memory 412), as with the platform 370, can also realize one or more trusted execution environments 418 for within the gateway. The gateway 375 can enhance communication functionality of sub-systems 315, 320 connected to the gateway and can provide identity for the sub-systems to allow for secured communication channels over which the native communications of the sub-systems 315, 320 can be tunneled. The gateway 375, through security management instance 365c, can additionally monitor all outbound and inbound communications involving each connected sub-system 315, 320, and can further perform filtering, blocking, protocol conversions, among other tasks, in accordance with one or more policies to be applied to each sub-system. Additionally, the agent 405b can provide a similar interface between the security management instance 365c and the backend security management service 360, to report events and conditions involving each of the sub-systems and enlist the assistance of the security management service 360 in securing each of the sub-system (e.g., by dynamically updating policies or deploying countermeasures that target communications of one or all of the sub-systems (e.g., 315, 320) connected to the gateway 375.

In one example, a backend security management service 360 can be a service capable of being provided to multiple different systems and can provide a normalized interface for reporting security events and deploying various organization-specific policies on the sub-systems of the organization. In one embodiment, a security management service 360 can be implemented using one or more processor devices 420, one or more memory elements 422, and one or more components (e.g., 424, 426, 428, 430, 432, 434, 436, 438) implemented in hardware and/or software-based logic. For instance, components can include such examples as an agent manager 424, a policy manager 426, authentication, authorization, and accounting (AAA) logic 428, an event manager 430, edge management 432, security analytics 434, global intelligence interface 436, and domain manager 438, among other examples. The security management service 360 can additionally manage and utilize data stored in one or more repositories 440. Such data may include information such as a criticality records 442, security assessment reports 444, asset records 446, threat records 448, vulnerability records 450, risk records 452, among potentially many other examples.

In one example, an agent manager 424 can be provided in security management service 360 to track the various agents (e.g., 405a,b) interfacing with the security management service 360. These agents can include both agents implemented on security management instances (e.g., 365a,c) as well as on other platforms. Secure communication channels, such as implemented using a tunneling protocol, can be utilized to communicate between the security management service 360 and each agent (e.g., 405a,b) and the agent manager 424 can assist in establishing these secure channels as well as mapping the channels to the target agents. Additionally, an agent manager 424 can map each instance of an agent (e.g., 405b) to each asset (e.g., 315, 320, 375) that is monitored by the agent. A policy manager 426 can be used to determine policies for each network and system secured using the security management service 360. The policy manager 426 can identify the policies that are to be pushed to each agent such that broader policies applicable across a system are enforced. For instance, information generated by edge management 432 logic and/or security analytics 434 can be used by the policy manager 426 to identify events or conditions that can trigger a policy change to be pushed to one or more agents (e.g., through agent manager 426).

The security management service 360 can implement security as a service for a variety of different customers. This can allow a security context to be provided that is independent of and separated from the operational context of the systems and component subsystems of any one customer. However, in some implementations, to the extent that an overlap exists between the security and operational context, an operational interface 430 can be provided to expose certain findings of the security management service 360 to the operational management system of a customer used to manage the customer system's operational context. As an example, an operational management system can dictate the operational parameters and policies to be followed by the system. These can be very specific to the particular business of the customer organization. However, security events can be reflected in divergences from business or operational norms. For instance, if a hacker is attempting to cause a piece of computer-controlled machinery to malfunction by hacking the controls of the machinery through a network, operational abnormalities may be observed by the operational management system. The security context, as identified, and managed by security management instances and security management service 360 in the customer's system may detect and manage the underlying network security issues that caused the operational abnormality. While these root security causes may be under control, it can still be useful to expose this intelligence to the separate operational management system to provide context for the operational abnormalities, among other examples.

The services that security management service 360 can provide to systems implementing security management instances (e.g., 365a, 365c) within their respective systems (e.g., 315, 320, 408) can be varied and include such examples as network and transaction authentication and authorization assistance, remote attestation, security analytics, security-based services orchestration, risk analysis, among other examples. The security management service 360 can additionally provide edge management for the various security management instances, including managing edge, or endpoint, device settings (physical interfaces, network addresses, routing, firewall settings, heartbeat messages, etc.) and diagnostics (e.g., monitor and manage which processes are running on the end point, data throughput, network activity, etc.). Further edge management can include management of other settings and activity at the endpoints including system settings (e.g., access control, passwords, time, startup, tasks, file systems, security features (including hardware-based security features), backup & long-term storage, etc.) as well as direct controls such as remote rebooting of the device, among other examples. The security management system can additionally manage data structures to track the various endpoints/assets managed by the security management system, including management of the latest software updates or other versioning at the endpoints (both the security management instance and application instance), policies, and identity.

As an example, through the information (e.g., as recorded in assessment records 444) provided to the security management service 360 from various agents (e.g., 405a,b) inside and outside a given system, security management service 360 can identify trends, emerging threats or attacks, determine conditions at individual assets within a system, or within a broader subsystem or system. The security management service 360 can also consider other intelligence when making determinations of threats and events that could influence which policies to enforce and how. For instance, global intelligence sources can be accessed by the security management service 360 that include information relating security conditions, trends, and other intelligence collected from other systems (e.g., outside the direct sphere of security management service 360). For instance, global intelligence can identify new attacks, malware, vulnerabilities, etc. that have been identified by other security tools and systems (but have yet to be detected (or identified) by the tools within the sphere of the security management service 360). The security management service 360 can utilize this intelligence together with system-specific information collected from agents (e.g., 405a,b) to better assess and manage security at the individual assets managed using security management instances (e.g., 365a, 365c). Indeed, security management service 360 can develop and have access to a wealth of information collected from a variety of sources includes information regarding how to regard the criticality of various assets (e.g., through criticality records 442) and related risk profiles (e.g., in risk records 452), the identity and attributes of various assets managed by the security management service 360 (e.g., asset records 446), information describing various threats (e.g., in threat records 448) and vulnerabilities (e.g., vulnerability records), among other examples. Further, as noted, the security management service 360 can be offered a service for consumption by multiple diverse system and customers. A domain manager 438 can be used to differentiate between the attributes and policies of the customer systems to customize the security services provided to each respective system.

In general, “servers,” “devices,” “computing devices,” “host devices,” “user devices,” “clients,” “servers,” “computers,” “systems,” etc. can include electronic computing devices operable to receive, transmit, process, store, or manage data and information associated with the computing environment. As used in this document, the term “computer,” “computing device,” “processor,” or “processing device” is intended to encompass any suitable processing device adapted to perform computing tasks consistent with the execution of computer-readable instructions. Further, any, all, or some of the computing devices may be adapted to execute any operating system, including Linux, UNIX, Windows Server, etc., as well as virtual machines adapted to virtualize execution of a particular operating system, including customized and proprietary operating systems.

Host and user devices can further computing devices implemented as one or more local and/or remote client or end user devices, such as personal computers, laptops, smartphones, tablet computers, personal digital assistants, media clients, web-enabled televisions, telepresence systems, gaming systems, multimedia servers, set top boxes, smart appliances, in-vehicle computing systems, and other devices adapted to receive, view, compose, send, or otherwise interact with, access, manipulate, consume, or otherwise use applications, programs, and services served or provided through servers within or outside the respective device (or environment). A host device can include any computing device operable to connect or communicate at least with servers, other host devices, networks, and/or other devices using a wireline or wireless connection. A host device, in some instances, can further include at least one graphical display device and user interfaces, including touchscreen displays, allowing a user to view and interact with graphical user interfaces of applications, tools, services, and other software of provided in environment. It will be understood that there may be any number of host devices associated with environment, as well as any number of host devices external to environment. Further, the term “host device,” “client,” “end user device,” “endpoint device,” and “user” may be used interchangeably as appropriate without departing from the scope of this disclosure. Moreover, while each end user device may be described in terms of being used by one user, this disclosure contemplates that many users may use one computer or that one user may use multiple computers, among other examples.

While some of the systems and solution described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

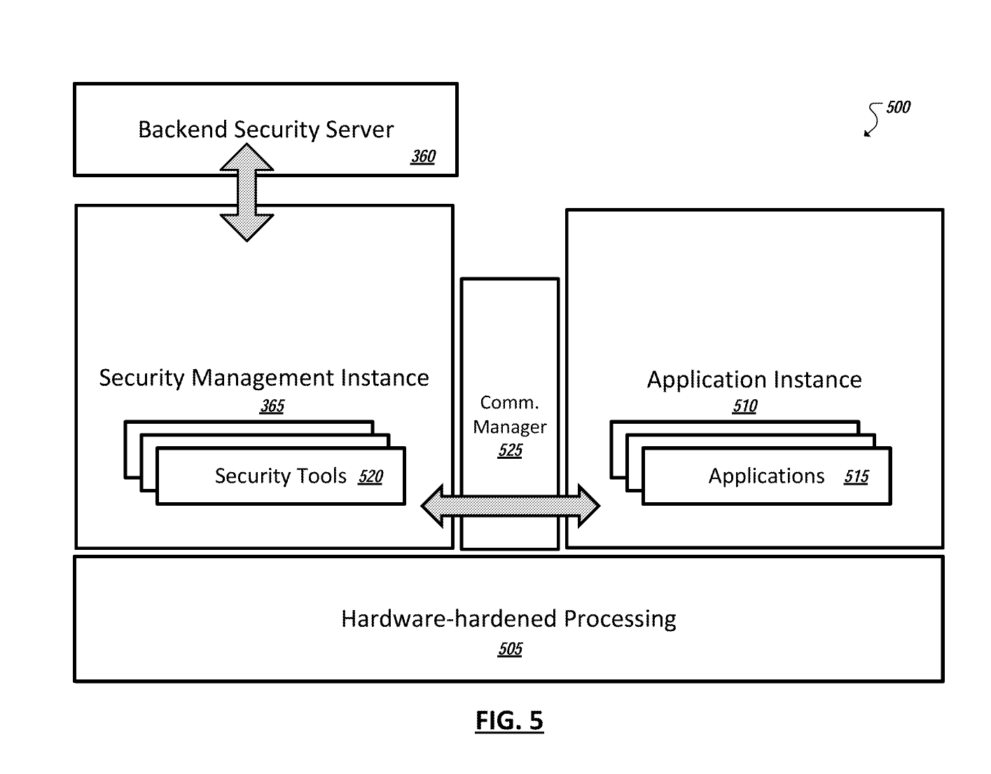

Turning to the example of FIG. 5, a simplified block diagram 500 is shown illustrating an example implementation of a security platform (e.g., 370), instances of which can be used across a system to host a variety of different applications in the system. For instance, the platform can be built upon a secured hardware, such as a physical processor device 505 configured to support and host encrypted operation modes, virtualization environments, containerization, or other security features. The physical processor device 505 can also include hardware-based security features. Such hardware-based security features can include, for instance, a trusted platform module (TPM) implemented as a separate hardware chip to securely perform cryptographic operations in support of identity, integrity, and confidentiality functions. In another example, a manageability engine can be provided on the hardware platform as a security co-processor that can be used to execute portions of the logic of the security management instance. The processor device 505, in some instances, can provide modes of encrypted processing sessions through hardware-enforced encryption that can be implemented based on source code commands, among other examples. A secure processor 505 can represent an improvement over a native processor of a computing system that is used in the sub-system that is to be instantiated on the platform and replace the original deployment of the sub-system. Additionally, at least a portion of the security management instance can be provided that is outside of the operating system of the environment, such that security is provided below the OS kernel of the environment supporting the sub-system.

The platform can provide separation between the security management instance 365 and the application instance(s) 510 representing the operational context of the sub-system. The processing platform 505 can assist in enforcing separation, through virtualization, containerization, encrypted processing, etc., between the management instance and application instance by creating boundaries in memory, processor (e.g., CPU) use, and other physical components (e.g., network adapters, peripherals, storage controllers, etc., among other example features.

The security management instance 515 can encapsulate the application instance, such that all communications in and out of the application instance (by its composite applications 530) go through the security management instance and secured using one or more security tools 520. For instance, secure communication tunnels can be established by the security management instance, to secure all communication between the platform and the outside systems with which the application instance 510 attempts to communicate. Further, all data accesses by the application instance 510 can also be routed through, and processed by, the security management instance. The platform separation, however, makes involvement of the security management instance invisible to the application instance, such that the applications 515 can be instantiated in their native form (and even execute within their native operating system) without being otherwise modified to accommodate the additional security features provided by the security management instance. Indeed, such modifications can alter, and in some cases, jeopardize the operational context of the original applications 515.

In some implementations, communication between the instances 365, 510 (in connection with proxying communications and data operations of the application instance) can be restricted to defined mechanisms such as provided through a communication manager 525. The communication manager 525 can be present itself to the application instance as virtualization of a gateway or other network interface such that the management instance (behind the communication manager) is invisible to the application instance, and believes that it is connecting directly with a network through the communication manager 525 (i.e., and not via a separate management instance 365). In some instances, a communication manager 525 can be loaded with protocol converters to allow specific protocols (e.g., used by an application instance) to be transformed into more modern and securable protocols. The communication manager 525 can implement an embedded stateful firewall including a protocol-level firewall. Additionally, the communication manager 525 can define and enforce authorization rules that describe what kind of traffic is allowed to pass between the application instance(s) and the management instance as well as between multiple application instances on the same hardware (e.g., in such instances where multiple application instances are provided on the same platform). Further, in cases where multiple application instances are provided on a platform, the communication manager 525 can perform routing operations to instruct the security management instance as to the source (e.g., which application instance) of any given transaction or communication.

Continuing with the example of FIG. 5, applications 515 can be instantiated within the application instance and function just as they do on the native platform hosting the application. Further, as noted above, multiple separate application instances can be provided on a single platform and can each interface with a management instance 365 via a single communication manager 525. The communication manager 525, in such implementations, can multiplex the network communications and transactions to be processed over the management instance 365 to allow the logic and functionality of the management instance to be reused for multiple application instances. The communication manager 525 can also secure communications between the multiple application instances, among other examples.

All or a portion of the native platform can be replaced by the platform shown and described in connection with FIG. 5. This allows the application to proceed as it always had, but with a cloak of security provided by security tools 520 of the management instance 365 and the protections provided through the secure processing platform 505, and other enhanced components of the platform. Further, the management instance 365 can contribute functionality (without changing the application 515) that allows backend and cloud-based security management systems and services (e.g., 360) to participate in the management and protection of the application instance (and applications 515 executed in the application instance). In some implementations, the platform can implement or adopt one or more features described in U.S. patent application Ser. No. ______ filed ______, 2014 and entitled “SEPARATED APPLICATION SECURITY MANAGEMENT”, which is hereby incorporated by reference herein.

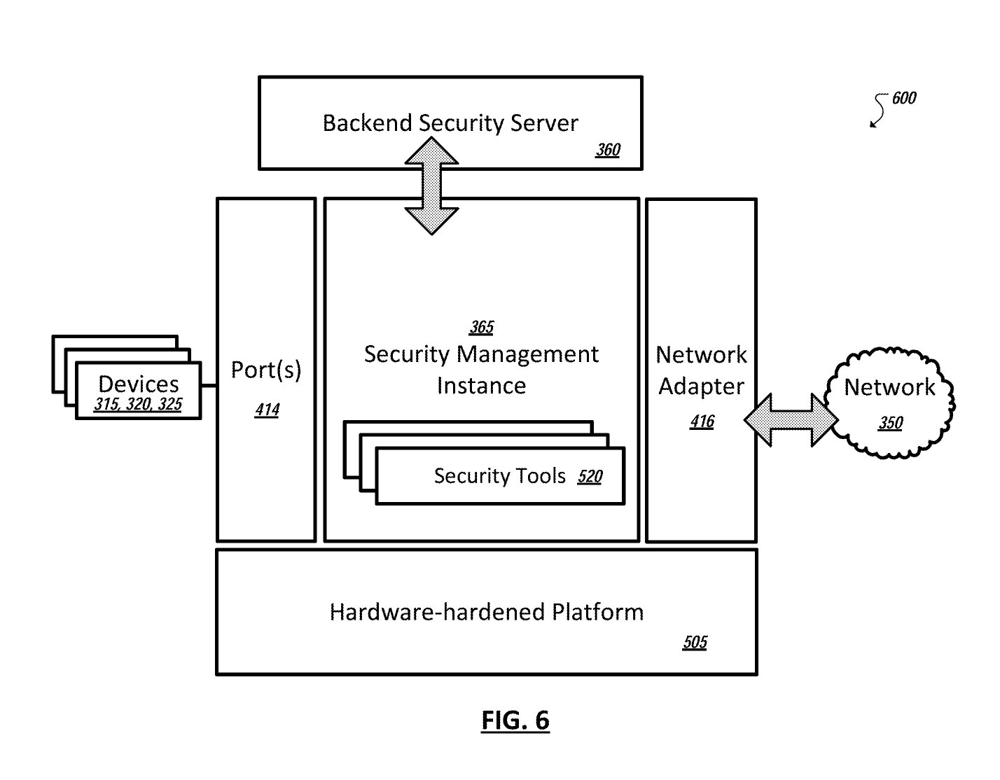

FIG. 6 shows a simplified block diagram 600 illustrating an example implementation of a secured gateway (e.g., 375). As is apparent from a comparison with the example implementation of a secured platform as illustrated in FIG. 5, the secured gateway can share a similar security management instance 365 built upon a similarly-hardened processing platform 505. A common set of security tools 520 and functionality can be provided in the security management instances 365 as implemented on either a secured platform or secured gateway. The common set of security functionality can facilitate a unified approach to security policy definition and enforcement across a wide variety of subsystems and assets (e.g., 315, 320, 325, 515). Despite these core similarities between secured platforms and secured gateways, some variations may exist. For instance, in addition to possessing ports 414 and network adapters 416 and other network gateway logic, additional security tools can be provided in implementations of the security management instances implemented in secured gateways to address securing a gateway specifically as well as providing additional features used by the secured gateway to provide additional computing functionality for the sometimes “dumb” components it may be tasked with protecting, such as generating synthesized embedded identity for the devices 315, 320, 325, etc. Additionally, while similar hardware features may be implemented to provide secured processing, virtualization, containerization, etc. used to secure the security management instance, hardware of the gateway may be different from that used in secured platforms, for instance, to facilitate the gateway specific logic of the secured gateway. These potential differences notwithstanding, both the security management instances of secured platform and secured gateway can provide a core standard of security infrastructure to encapsulate the system assets protected by each.

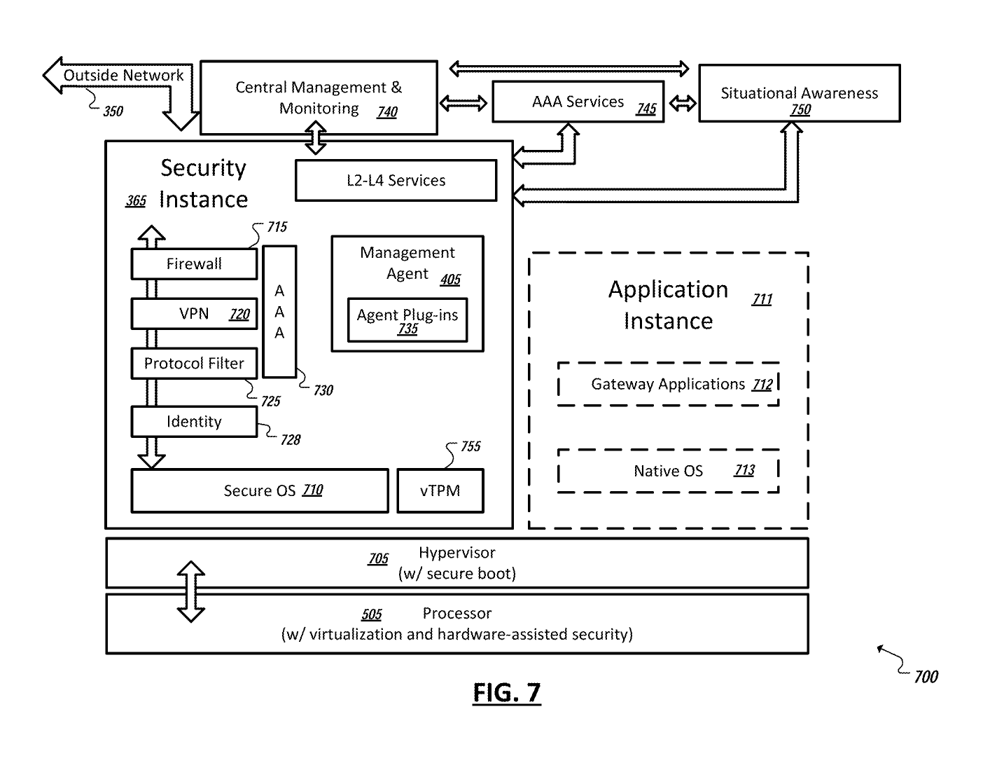

FIG. 7 is a simplified block diagram 700 showing a more detailed representation of a particular example of a security management instance 365 to be implemented in a secured gateway to secure one or more subsystems or assets (or “connected assets”) communicatively coupled to the secured gateway either by wireless or wireline connections. The security management instance 365 (whether employed on secured platforms or secured gateways) can be used to standardize security across a variety of different computing devices in a system. The gateway can connect to an unmodified, native version of the subsystem or asset to be secured by the security management instance 365. The security management instance 365 can effectively envelop the connected devices in enhanced security by monitoring and securing all communications in or out of the device.

The tools and components of the management instance 365 can be executed on a secure operating system 502 that includes functionality to harden the operating system from attacks generally, as well as specifically guard against attacks targeting the management instance 365. In one example implementation, secured processor 505 can include functionality for virtualizing the operating environment of the security management instance 365 as well as optional application instances (e.g., 711) that host gateway-specific applications (e.g., gateway management and analytics applications) 712 that may execute on proprietary, unsecured, or legacy operating systems (e.g., 713).

In an alternative implementation, the code of the security management instance (or blocks of the security management instance) can include hooks to trigger a processor (e.g., 505) to enter an encrypted executing state wherein it encrypts execution of particular processes (e.g., of the security management instance) using an encryption key or certificate private to and stored in secure memory of the processor. In still other examples, the secure containers can be provided in which one or more blocks of the security management instance or the entire security management instance, can execute and be protected from access by other (potentially malicious or compromised) processes, among other examples.

In the particular example shown in FIG. 7, the security management instance 365 can include an operating system 710 layered with security features such as memory randomization, intrusion detection and prevention tools, AAA checks, secure UEFI boot measurement, and runtime security (e.g., handled using a management agent in connection with one or more backend security services), among other examples. In addition to security tools and features configured to protect the integrity of the security management instance 365 itself, the security management instance 365 can include various tools to secure communications of devices connected to the gateway (as well as protect any application instance (e.g., 711) offered on the gateway device). For instance, a security management instance 365 can include various security components and logic, such as a firewall 715, virtual private network (VPN) (or other tunneling protocol) manager 720, protocol filter 725, AAA module 728, identity manager 728, among other tools, such as a virtual trusted platform module (vTPM) 755.

The security management instance 365 can additionally include an agent 405 that can interface with a backend security management service (e.g., 360). In some implementations, security management service 360 can be implemented as multiple different components or sub-systems. For instance, an agent 405 can interface with remote security management components (over a secured, out-of-band network connection) such as a centralized management and monitoring service 740, AAA services 745, and situational awareness services 750, among other sub-systems. The agent 405 can also include functionality for performing security-based monitoring of the functioning of the security management instance itself (e.g., to check that the security management instance is not being attacked or otherwise undermined), as well as monitor and report information relating to the inbound and outbound communications routed over the security gateway of assets connected to the secured gateway.

In some implementations, the security management instance 365 can also encapsulate the functionality of the gateway such that all incoming and outgoing communications involving the gateway can be intercepted, processed, and secured using security tools of the security management instance. Further, any ports or peripheral inputs provided on the gateway can also be monitored and secured by the security management instance. Security can be provided in components of the gateway outside the security management instance, to support the security management instance. For instance, a TPM, manageability engine, or secure boot capability can be provided in hardware of the gateway to support the security management instance's operations as well as potentially secure the security management instance itself. As one example, a secure boot can be used, by which a trusted execution environment (TEE) can measure the boot process of the gateway hardware and attest to the integrity of it and the files embodying the security management instance, secure OS 710, etc., by comparing the present configuration of the system with a previous (or last trusted) version of the system, among other examples. The security management instance can send results of an attestation analysis to a backend security service for use by the backend security service in determining the authenticity and/or security status of the corresponding asset or security management instance. Other attestation information can include location information (e.g., obtained from a geopositioning sensor on the asset or security management instance), identity information (e.g., obtained from a secure memory (e.g., hardened memory, fuse-based key, secured processor, etc.), or other information that can be used to attest to the conditions or identity of a particular security management instance or asset protected by the security management instance. To perform attestation, the attestation data can be compared against a pristine, “known good” data set (e.g., a hash or a set of hashes) maintained at a trusted backend security management service. Accordingly, the backend security management service can perform (or delegate another trusted service to perform) the comparison of received attestation data with corresponding known good values. The backend security management service can then perform an action based on the result of the comparison. For instance, if the attestation data does not match the known good set, a detection or prevention action can be performed. For instance, a detect action can include generating a message to notify appropriate personnel or software services (like the analytics, dashboards, and such) that there is a problem (given the attestation result). In prevent mode, a security management service can remotely block boot completion, block data transport, or quarantine and re-image the device, among other examples.

The extent to which the security tools perform various tasks and under what circumstances can be dictated by policies applied at the security management instance. For network communications entering and exiting the gateway involving one of the connected assets can be parsed and analyzed by one or more security tools of the security management instance. The gateway can provide a variety of ports to allow multiple devices using potentially multiple different connection mechanisms (e.g., USB, Ethernet, WiFi, Bluetooth) to connect to through the gateway. Further gateway can present itself to the assets it is connected to such that the gateway's involvement in invisible to the connected assets.

Assets can connect to various other devices or even network-connected devices over the secured gateway. The security management instance can include identity generation logic 728 to generate synthesized identity for each of the gateway's connected assets. Indeed, in some instances, the assets connected to the gateway may possess neither the concept of identity, much less the functionality for providing identity that is both reliable and secure. For instance, the security management instance can synthesize (at the gateway) embedded identity for each of its connected assets, such that the identity of the assets can be attested to. In some implementations, secured hardware, such as a TPM or vTPM, can be used to generate and secure certificates on behalf of each of the connected assets. Such identities may be necessary to perform and implement authentication, authorization, secure tunneling, trusted transaction spaces, and other features that are to be provided in connection with one or more policies (and facilitated by the security management instances distributed throughout a system).

In one implementation, identity can be generated by identity logic 728 in connection with a backend security management service (e.g., 360). For instance, the secured gateway 375 (e.g., using identity logic 728) can create an identity that includes a corresponding public/private key pair. The public key can be shared with the security management system 360 during provisioning. The security management system 360 may then create a certificate from the public key and further use that in other systems (e.g., other backend asset management systems) to make the systems aware of the existence of this asset (805) (e.g., even when the asset (805) is completely unaware of the involvement of these backend systems or its own presence within a larger system). The identity generated by the secured gateway can be used, for instance, to mutually authenticate to other devices or systems, for instance, in connection with the establishment of a secure tunnel, among other uses.

As noted above, the security management instance of a gateway can utilize identity generated by identity logic 728 to establish secure communication tunnels, such as a VPN tunnel (e.g., using VPN module 720) over which the traffic of an asset can be securely sent and received. Further, AAA logic can be used to authenticate and determine permissions of another device or system that is to connect to the asset over the gateway. Further, as the tunnel terminates at the gateway, the security management instance 365 can inspect the contents of all data to be sent or received over the tunnels established by the security management instance to enforce one or more policies at the asset. For instance, a firewall 715, protocol filter 725, and agent 405 (among potentially other tools) can be utilized to protect the connected assets from threats originating from or utilizing the network connection.

As examples, the firewall 715 can be provided to protect against malicious communications (or any other communication that is counter to a policy established for the device and its application), whether the communication is ingoing or outgoing. As an additional layer of security, network protocol protections can also be deployed that include protocol filters (e.g., 725) capable of monitoring traffic that does make it through the firewall on the tunnel (i.e., after decryption at the management instance) to determine the protocol used in the communication and test the data for compliance with the protocol (e.g., to identify buffer overflow attempts, injection attempts, malformed packets, etc.). Protections can also be extended to address asset-specific concerns, such as monitoring the legitimacy of commands received over the tunnel (e.g., otherwise protocol-compliant commands that deviate from what is expected, such as repeated commands to turn a pump on and off during a short duration (i.e., in an attempt to cause a malfunction or damage to the pump)) and blocking or suspending commands that violate rules or policies for the device, among other examples. Additional network control functionality can also be provided at the security management instance 365, such as a terminating proxy that re-generates clean packets from data received by the security management instance at the exit of a secure tunnel before forwarding these to the application instance (e.g., to guarantee that packets passed to the connected asset are “clean”, regardless of whether the incoming packets were malformed or not). Further authentication, authorization, and accounting (AAA) functionality (e.g., 730) can be provided to pre-authenticate devices and software attempting to communicate with a connected asset prior to allowing the connection to be made and data to be sent targeting the asset (e.g., whether the asset initiates the communication or not).

Security tools of the management instance can be complimented by real-time security provided through a management agent 405 provisioned on the security management instance 365. The agent 405 interfaces both with the security tools on the security management instance (e.g., via application control, change control, etc.) and with backend security systems, including a central management monitoring system 740, AAA services 745, and situational awareness system 750. (In some implementations, AAA component 730 can likewise (or instead) provide the interface between the security management instance and at least a portion of the AAA service 745. AAA services 745, as an example, can provide authorization (e.g., via Kerberos) to allow two devices (e.g., the platform and an external endpoint device) to communicate with each other in a trusted fashion.) Further, a secure communication channel can be established between the agent 405 and the trusted backend services (e.g., 740, 745, 750) such as through a Transport Layer Security (TLS) tunnel, a virtual private network connection, or other examples.

The management agent 405 can monitor events on the security management instance 365 as generated, for instance, by security tools (e.g., 715, 725, 730, etc.) and can report these to one or more of the backend services. Further, the agent 405 can collect information relating to interactions and activities of the security management instance, its operating system 710 and various security tools, including the processing and management, by the management instance, of the network connections of its connected assets. Further, the functionality of the agent can be extended, for instance, through agent plug-ins 735, such as plug-ins allowing application control, and change control management, among other example functionality. Such plug-ins 735 can be provided to the security management instance 365 from a trusted backend service, such as central management service 740, including dissolvable plug-ins provided to address an immediate need detected by a backend service based on feedback information reported by the management agent.

The management agent 405 effectively has a view of all activity at the security management instance 365 as well as a view of all network activity involving one of its connected assets. In some implementations, this feedback information can be reported to a backend situational awareness engine 750 (or analytics or edge management logic) that can assess the information to identify likely application behavior, user behavior, or situational contexts at the gateway or its connected assets based on the information. For instance, the situational awareness engine 750 can be configured to identify trends, patterns, and heuristics that correspond to particular situations, including situations that are specific and relevant to an operational context of the system or asset. Additionally, the situational awareness engine, and other backend services (e.g., 740), can interface with multiple different management agents on multiple security management instances across a system and determine situational context based on information received from two or more of these agents.

In one implementation, in response to receiving and analyzing information delivered by an agent 405, a backend security management service may generate an alarm, which set “tags” on assets in the security management instance to cause policies to be pushed down to those assets based on the new state, cause notifications to be sent to appropriate personnel, etc. As an illustrative example, traffic involving repeated failed log-in attempts followed by a successful login attempt (i.e., implying that someone brute-forced a weak password on the endpoint subsystem) can be detected by a management agent 405 together with other events relating to a network connection. Data describing the same can be communicated up to the security service by the agent causing the backend security service to trigger an alert (e.g., based on a determination that this pattern of actions corresponds to a possible brute force attack). This alert can trigger a policy to be pushed down to the agent 405 to be applied at the management instance 365 to counter the potential threat at the secured gateway, for instance, by blocking further traffic from the source or a corresponding user, causing network activities to cease entirely, among other example countermeasures responsive to the possible situation of a malicious actor attempting to compromise the connected asset.

Alerts can be based on determining deviations beyond threshold behavioral profiles for a connected asset or the security management instance 365. A baseline can be recorded (e.g., on the security management instance, and/or based on monitoring other deployments of the platform possessing respective agents) to indicate the types, amounts, and timing of activities that are expected at a security management instance. Correlation logic (e.g., of a backend security management service) can store each atomic component of this baseline for use in comparing subsequent conditions described in incoming data reported by the agent to determine whether activity at the security management instance 365 deviates beyond a corresponding threshold. Further, by monitoring activity as it occurs on the device, precursors to a known type of attack can be identified. Attacks can be progressive in nature and thus, with each succeeding detected precursor, the state of the platform (and assigned policies) can be progressively and dynamically adjusted so as to anticipate subsequent, more damaging actions in an attack (i.e., following the precursor activities). The policies that are pushed down in response can be used to make the security management instance 365, and the connected assets, “moving targets” that respond evasively to the potential attack until the security management instance determines that the gateway should be entirely locked down before the security management instance is effectively compromised and the connected asset(s) are exposed.

In addition to determining deviations from expected behavior of a single component, or node, situational awareness logic in a backend security management service can also calculate risk scores for each node in a system and monitor how these nodes interact, the connections between the nodes, and use this information to identify how risk on one node might potentially threaten another node in the system that it communicates with. For instance, based on risk or threatening activity on other nodes in a network, the backend security management service can push down policy proactively in anticipation that similar threats may arrive at these other nodes (based on what was observed on another node). Indeed, all or a portion of the nodes can be implemented and secured using either a secured platform or secured gateway including a respective security management instance and agents reporting conditions on the corresponding asset. With a normalized interface provided between the assets of a system and the centralized security management service(s), system policies can be enforced and updated consistently across the system, and the respective security management instances, in communication with one or more centralized backend security management services, can orchestrate a concerted and complimentary response to attacks and threats to the system.

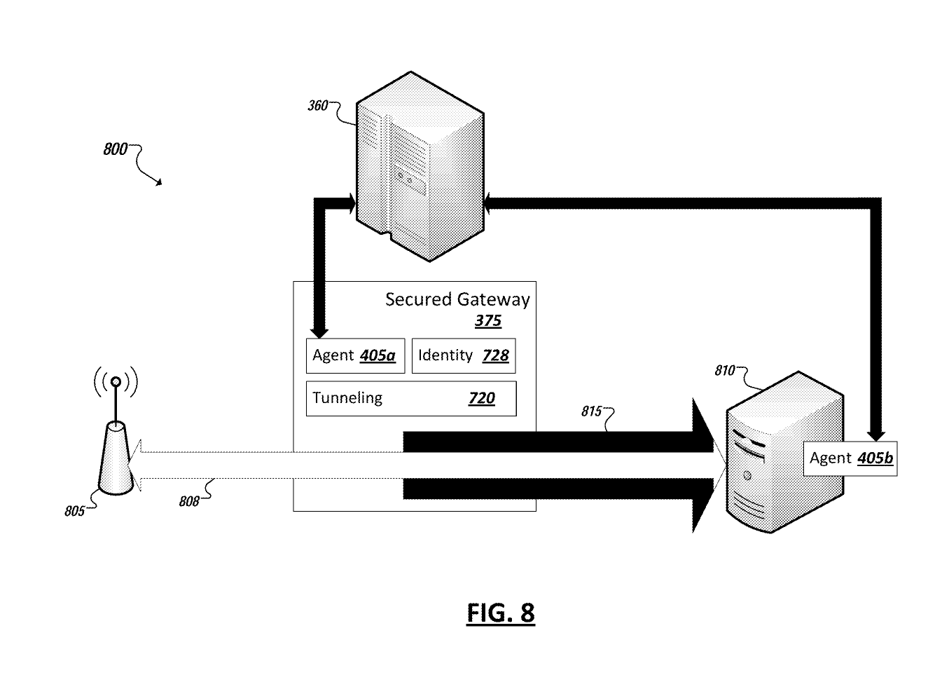

Turning to FIG. 8, a simplified block diagram 800 is shown illustrating an example secure tunnel provided by a secured gateway device 375 on behalf of endpoint assets (e.g., 805) connected to the gateway 375. One or more assets (e.g., 805) can be connected to a respective port of the gateway device 375. Without the assistance of the gateway device 375, the connected asset 805 may lack the network or computing resources to facilitate a secure network connection with a partner device 810. For instance, a connected asset 805 may lack a defined network identity making them unable to mutually authenticate (on their own) with another system. Further, a connected asset 805 may lack the logic to utilize communication security protocols and techniques, such as Internet Protocol security (IPsec), as well as lack cryptographic processing capabilities so as to handle cryptographic algorithms utilized in encrypting and securing a tunnel.

A secured gateway 375 can provide logic on behalf of assets that can be connected to it, so as to allow the assets to communicate over secured tunnels. For instance, upon connection to the gateway 375, the secured gateway can generate an identity for the asset. Further, the secured gateway can generate keys, certificates, and/or other authentication data for use in mutual authentication and encryption protocols to be utilized in establishing a secured tunnel and tunneling data to be communicated to and/or from the asset over the secured tunnel. For instance, the secured gateway can generate a public key (e.g., using a secure, hardware-based resource) and can engage in a public key exchange on behalf of the connected asset with a potential secured connection partner. The secured gateway can then negotiate a shared key on behalf of the connected asset for use in the tunnel, among other example implementations.

As shown in the example of FIG. 8, secured gateway 375 has generated an identity and authentication data (e.g., using identity 728 and/or tunneling logic 720) for agent 805 and established a secure tunnel 815 between the secured gateway 375 and an endpoint system 810 with which the asset is to communicate. For instance, the asset 805 may be an electronic controller for a piece of equipment and endpoint system 810 may be configured to manage automation of the equipment by sending signals 808 to the asset as determined appropriate by the endpoint system 810. The endpoint system 810 may be connected to the Internet or another network, thereby exposing the endpoint system (and thereby also the asset 805) to one or more network based vulnerabilities. Sophisticated security tools may be capable of being installed and run on the endpoint system 810 to provide security at the endpoint system. However, the lean logic provided on asset 805 may not allow easy modification of the asset 805 to provide similar security. This notwithstanding, it may be possible (without secure tunnel 815) for an unsecured connection 808 between the asset 805 and the endpoint system 810 to be exploited. Worse still, if the endpoint system 810 is an untrusted or malicious endpoint (such as a system spoofing a trusted endpoint system), the asset 805 could be fully vulnerable to attack.

In the example of FIG. 8, endpoint system 810 has an agent 405b installed on it or a corresponding security management instance for the endpoint system (such as in instances where the endpoint system is implemented on a secured platform). Data received from the asset 805 can be intercepted and monitored by security tools of the security management instance on the secured gateway 375 and approved prior to being allowed to be sent further on to the endpoint system 810 through secured tunnel 815. Similarly, data received from the endpoint system 810 can be intercepted at the end of the secured tunnel 815 by the secured gateway 375 and can be processed by one or more security tools at the secured gateway 375. An agent 405a on the secured gateway can report information obtained from the intercepted data (whether received or sent by the secured gateway over the tunnel 815) to backend security management system 360 both to provide intelligence to the security management system 360 regarding the connection 808 between the asset 805 and endpoint system 810 and potentially enlist the security management system 360 in determining what policies to employ (and how to employ these policies) to data intercepted at the secured gateway. Intelligence received from the secured gateway's agent 405a can be compared, by the security management system 360, to information received from an agent 405b received at the endpoint system 810. In this manner, the security management system 360 can possess end-to-end visibility into network security of a system (including endpoint system 810 and asset 805) and fine tune the performance of security management instances' securing of the system by responding to this intelligence, even in real time, by providing policy and feedback data to agents (e.g., 405a, 405b).

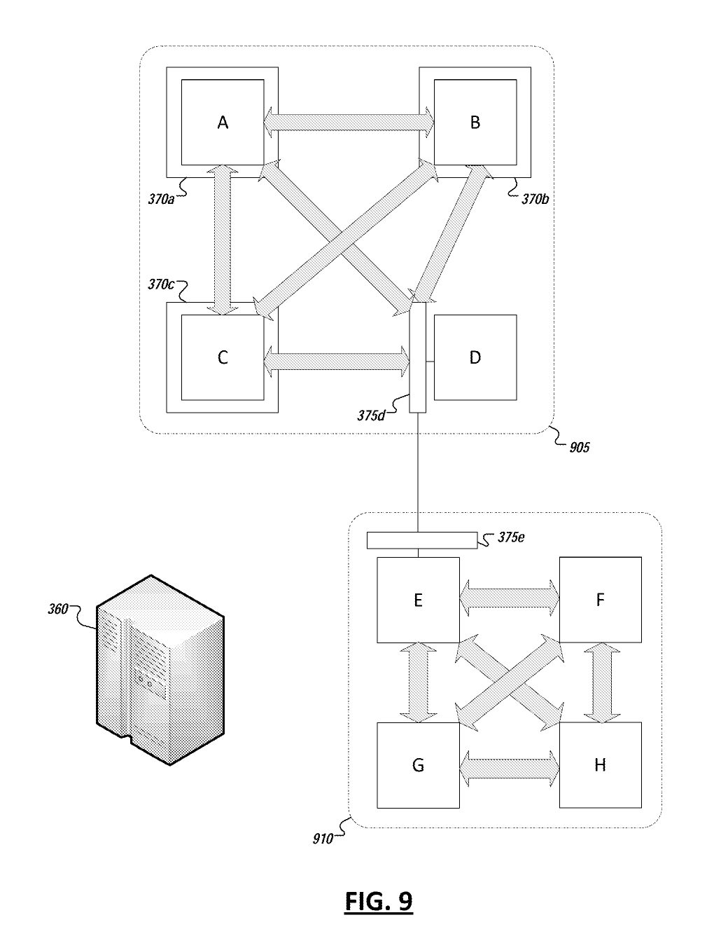

A backend security management system 360 can be utilized, in some implementations, to define and enforce policies that create trusted transaction spaces. Turning to FIG. 9, a system may be defined to include Assets A-H. Some of the assets may be protected using secured platforms (e.g., 370a-c) and secured gateways (e.g., 375d,e). Other assets (e.g., Assets F-H) may rely upon the security of other assets, such as assets (e.g., Asset E) secured by a secured gateway (e.g., 375e). While connections between the assets may technically enable communication between any two assets in the system, one or more policies can be defined and enforced (e.g., using secured platforms (e.g., 370a-c) and secured gateways (e.g., 375d,e) together with corresponding agents in communication with a backend security management system 360) to define limited trusted transaction spaces constraining communications to only those between assets in a given trusted transaction space (e.g., 905, 910). For instance, a security management instance can monitor communications at any one of the security management instances and filter those communications that do not conform to the -specific policies defined for each trusted transaction space. Such policies may restrict, for instance, communications generated from an asset outside of a trusted transaction space, communications in connection with a transaction type not in compliance with the trusted transaction space's policies, communications received according to a particular frequency or during a particular time of day, among other examples. In some instances, secured gateways can serve as the guardians between the various trusted transaction spaces, as well as serve as the point-to-point connection between the connected assets themselves.

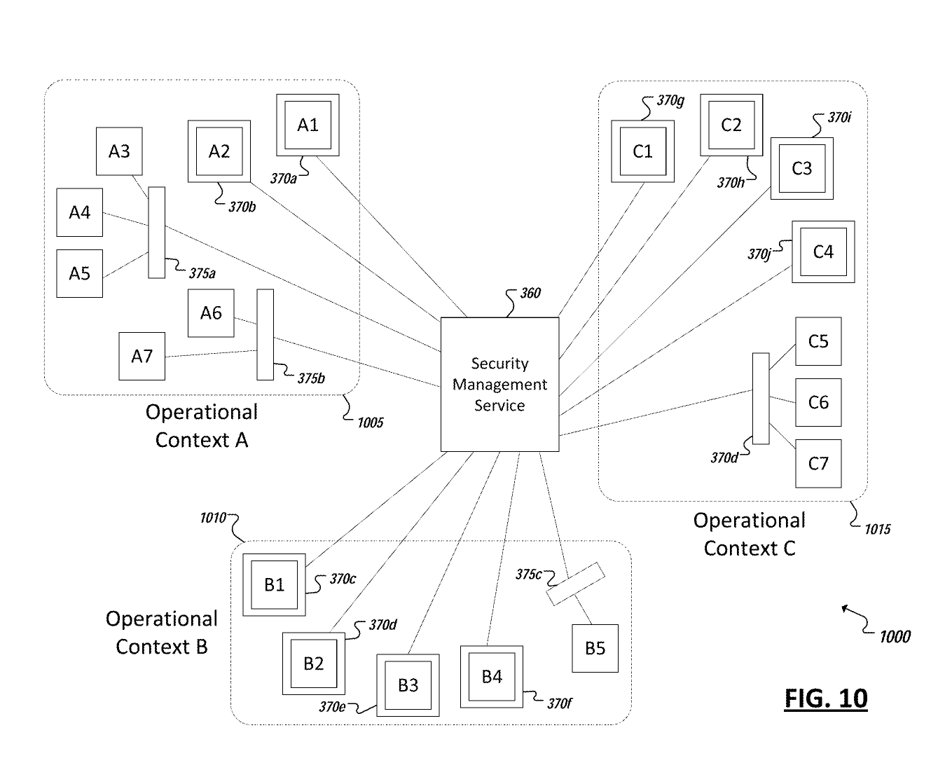

A backend security management system (e.g., 360) can be provided as a service for consumption by the systems and networks (e.g., 1005, 1010, 1015) of potentially multiple different organizations and entities, as illustrated in the simplified block diagram 1000 of FIG. 10. In accordance with the various businesses, initiatives, and purposes of the organizations, and their respective use and design of their systems 1005, 1010, 1015, each system may have a wholly unique operational context. The operational context can pertain to what each system and its constituent components (e.g., assets A1-A7, B1-B5, C1-C7) are supposed to “do.” For instance, Operational Context A may be used by an airport to manage flights, including scheduling, arrival/departure status, baggage, etc., and various sensors and tools (including “dumb” devices) may be used to provide information to subsystems of system 1005 in connection with the management of flights. Other systems (e.g., 1010, 1015) may have entirely different operational contexts related to entirely different businesses or purposes, such as traffic signal management, plant management, utilities management, and so on. The operational context may even differ between systems and entities serving the same business (e.g., the operational context of one airport's flight management system can be specific to that airport and have an operational context different from the system employed in a different airport, among other examples).

A security management system 360 can obtain information relating to the security of each of the various systems 1005, 1010, 1015. Security can thereby be provided as a service, as each system 1005, 1010, 1015 can be exposed to essentially the same general types of computer and network security threats and vulnerabilities. Interweaving security tools within the software and hardware that is designed to provide the operational context of the system can be difficult, given the wide variety of different systems, tools, controllers, sensors, and software that are provided to implement and manage a given system's operational context. This can involve shoehorning customized security solutions into existent subsystems, not to improve the operational context, but to provide missing security (i.e., the security context). Such interweaving of the security context within the operational context can be expensive and lead to inconsistent security across the system. A security management system 360 can be configured for use with reusable secured platforms (e.g., 370a-j) and secured gateways retailoring each subsystem to obtain information from agents installed on subsystems of multiple different systems 1005, 1010, 1015. For instance, secured platforms (e.g., 370a-j) and secured gateways (e.g., 375a-d) can be deployed within each system 1005, 1010, 1015 to permit security management service 360 to assist in managing the security context of each respective system using a normalized interface. Further, security management instances on each of the secured platforms (e.g., 370a-j) and secured gateways (e.g., 375a-d) can provide a uniform level of security across each of the constituent assets and allow policies to applied and enforced to secure each of the systems.

A unique set of policies can be defined for each system 1005, 1010, 1015 and the security management service 360 can differentiate between the deployed security management instances and agents to identify which system (e.g., 1005, 1010, 1015) applies to which agent (and data to or from the agent). Accordingly, the security management service 360 can provide a customized security context to each of the systems 1005, 1010, 1015 that is functionally independent of each system's respective operational context. This can be achieved by employing secured platforms (e.g., 370a-j) and secured gateways (e.g., 375a-d) that employ separation by enshrouding and leaving undisturbed the operational functionality of each asset with security functionality provided by the corresponding secured platform or secured gateway.

While the security management for each system 1005, 1010, 1015 can be implemented separate from the operational context of each system, the set of security policies defined for each system can be based on the operational context. For instance, a library of policies can be available that can be enforced utilizing the logic of the security management system and the security tools available on each security management instance. The security management instance and security management service (together with the library of policies) can be extensible to facilitate management of new and evolving security issues as well. Each policy can be configured, for instance, to allow certain threshold values to be custom defined (e.g., defining prohibited or allowed behaviors, events, data attributes, or configurations, etc.), however, each policy may by hypothetically usable in any of systems 1005, 1010, 1015. Security administrators can select which policies to apply and where to apply them within their systems. For instance, security administrators may define trusted transaction spaces, system hierarchies, taxonomies, and other groupings of assets and can select sets of policies to be applied to each of the various groupings. Policies can be assigned on an asset-level as well in some implementations. Further, system-wide policies can also be defined. A security management service can determine when to temporarily and permanently push additional policies or modifications to policies that are to be applied to any given asset or grouping of assets based on system-wide policies. Such changes can be determined and made automatically by the security management service to address detected issues within the system (e.g., 1005, 1010, 1015) in real time.

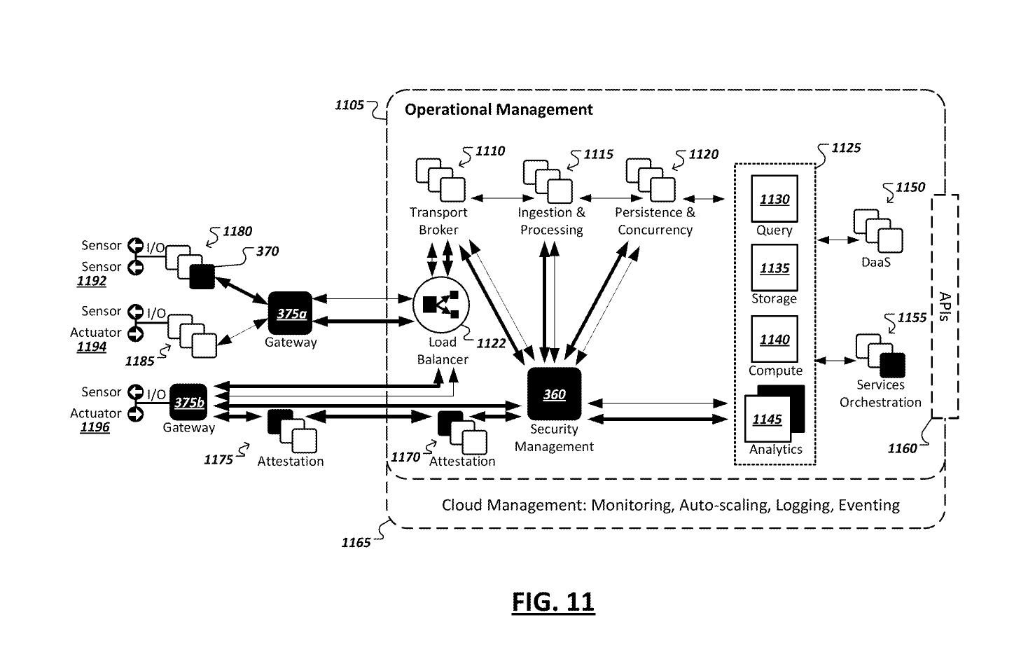

Each system 1005, 1010, 1015 can have one or more subsystems for managing the operational context of the system. Such operational context management can be at least partially centralized. Further, operational management can be implemented using remote, distributed, or cloud-based computing resources. FIG. 11 shows a simplified block diagram of an example operational management system 1105. An example operational management system can include one or more computing devices hosting a variety of components embodied in hardware and/or software logic to monitor, control, and otherwise manage how the various subsystems (e.g., are to interact and interoperate within the system. Such components can include components for handling, routing, processing, and storing operational data generated and transported within the operational context of the system. For instance, such components can include a transport broker 1110, data ingestion and processing module 1115, a data persistence and concurrency module 1120, a load balancer 1122, and a database system 1125 including utilities such as a query engine 1130, storage manager 1135, computational logic 1140, and analytics logic 1145, among other examples. By separating the security context from the operational context, operational data and flows can be independent of the security data and security data flows.

In some implementations, operational management system 1105 can coordinate how operational data is distributed, packaged, and used by other services both inside and outside the system. For instance, portions of the data of database system 1125 can be exposed through data as a service engines 1150, which can prepare and abstract the data from database system 1125 into a form suitable for consumption by outside services (e.g., through APIs 1160). Services orchestration modules 1155 can also interface and coordinate interoperation with other services, including subsystems of the operational management system. For instance, alerts, events, graphical presentations, and other transactions can be coordinated through services orchestration logic 1155 (using APIs 1160). Additional logic can be provided in connection with some implementations, such as cloud-based implementations of an operational management system for a system, including cloud management platforms 1165 for monitoring, auto-scaling, logging, eventing, and other functions, among other components.

Multiple subsystems can implement the components of the operational management system 1105, including the database system 1125, load balancer 1122, and other sub-systems. Indeed, multiple computing devices can be used, for instance, in distributed versions of a subsystem. In FIG. 11, operational data flows between components are represented by unbolded connectors. Further, components dedicated to operational context are shown as white blocks while security components are shown in black. Further, the separate security data flows of the security context are shown as bolded connectors. While traditional systems integrate security into the operational context directly, these components can be replaced by the security components (e.g., 360, 370, 375a, 375b, etc.) which are provided as a service by a security management system 360 and security separation infrastructure (e.g., 370, 375a, 375b), such as described above.

Some operational components can be offered with security context components, such as with secured gateways 375a,b, an operational subsystem implemented on a secured platform 370, among other examples. Further, while attestation, data analysis, and other blocks may be provided within the operational context, separate security attestation and data analysis blocks can also be provided (e.g., as shown at 1145, 1170, 1175), for instance, as a service through a backend security management service.

Endpoint, or “edge”, devices of a system can represent computing systems, user endpoints, sensors, actuators, controllers, “dumb” and “smart” devices (e.g., 1180, 1185, 1192, 1194, 1196) that each have an operational context. Some of these devices, in their native form, may not have, nor be capable of supporting sophisticated computing and network security tools or even communicating with and consuming services of backend security services (e.g., 360). Accordingly, as illustrated above, some (or all) of this edge devices can be implemented on or in connection with secured platform elements (e.g., 370) or secured gateways (e.g., 375), such as described above. These secured elements (e.g., 370, 375) can secure at least some of the operational data streams, by tunneling operational data in secured communication tunnels. “Out-of-band communications” can also be facilitated between the secured elements and one or more backend security services (e.g., 360), and these too can be over secured communication channels. A backend security service (e.g., 360) can manage security for each of the system assets served by an agent, with the agent providing visibility into the security of each such asset. Additionally, security data obtained through the agents can be mined and processed through data analytics logic (e.g., of a backend security service). Additionally, security-related services can be provided in connection with security events determined by the backend security service. Other systems and services can consume or be the beneficiary of these alerts (e.g., generated by a security service orchestration block). Indeed, system security information and alerts can be exposed to operational services, including operational management system 1105, for use in adding context to operational events detected by operational management system 1105. Similarly, services orchestration for the operational context can be provided to a security management system to provide the security management system with context for its assessments.

System attestation can be provided in some implementations. Attestation can include boot analysis-based, location-based, and identity-based attestation. Operational management system 1105 can utilize attestation (e.g., 1170) to confirm the location of an asset within the operational context (e.g., in operational processes that are reliant upon an asset being in the right locations). Attestation logic can be provided for security management, with attestation information provided to attestation logic of a security management service to determine whether an asset has been tampered with, is who it says it is, etc. Likewise, edge devices can include attestation logic (e.g., 1175) to attest to characteristics of other systems and subsystems with which they are to interact, including security and operational management systems, among other examples.

To illustrate some of the principles and systems described above, an illustrative example is provided, involving the provision of a separation security architecture (such as set forth above) to secure subsystems of an industrial plant. The plant may make use of pumps or valves to control sensitive equipment of the plant, some of these may be connected to, automated, or controlled by an automation tool that is connected to a network. Accordingly, the possibility exists (among other potential threats) that a malicious attacker might attempt to gain control of a valve or pump controller by hacking into the automation tools using the network, to cause the valve controller to operate abnormally in an attempt to break the equipment or initiate a dangerous outcome.

In the present example, a secured gateway can be positioned between a valve controller and the automation tool. Further, or alternatively, the automation tool can be instantiated on a secured platform. The secured gateway can secure the connection between the automation tool and the valve controller. Further secured gateway and/or secured platform can monitor the instructions communicated to the valve controller by the automation tool. For instance, an agent on the security management instance (of either the secured gateway or secured platform) can identify that requests are being sent by the automation tool to the valve controller to turn the valve on and off repeatedly. While the format and protocol of the request may be in compliance with policies defined for the channel between the valve controller and automation tool (e.g., as defined in a trusted transaction space), the backend security service may nonetheless identify that this activity is irregular. For instance, the backend security service can determine that the frequency and repeated nature of the requests is beyond an established statistical baseline determined (e.g., from agent feedback data) from previous communications or operational context information (e.g., provided by an operational context management system). In other examples, the backend security system may identify other situational abnormalities in otherwise compliant communications, such as transaction that occur out-of-sequence, at an unusual time, from an unusual source, at an unusual frequency, or reflecting another anomaly. Data collected from other devices can be used to corroborate that an activity at a particular device (or set of devices) is anomalous or potentially malicious.

Situational awareness logic of a backend security system can correlate and aggregate the information received from agents monitoring a given transaction (as well as other agents on other devices′) to determine alert conditions or changes in security state for a given asset, and make such determinations dynamically and predictively in near real time. For instance, the agent can collect log files of a security management instance corresponding to an asset and forward all of this information to a backend security service. The alert or state change may indicate a detected potential or likely ongoing or future attempt to compromise the security management instance (e.g., by a malicious actor)). The security management service can communicate alerts, events, state changes, etc. determined from data received from one or more management agents as well as determine remedies and policy updates that address the alert or state change. Further, a backend security service can push down policies or policy updates to corresponding agent to cause security tools at a corresponding security management instance to apply the updated policy and attempt to address the alert or state change.

As noted above, attempts to attack and take-over a security management instance and/or compromise a protected asset can be forecast based on events detected by the security management instance. For instance, multiple unsuccessful log-in attempts, attempts to access unauthorized files, attempts to perform actions for which the user does not have authorization, and other attempts and actions can be identified by an agent or security tool of the security management instance can be reported, by the agent, to the backend security management service. While the attempts may be harmless in isolation, a combination or series of such attempts may be evidence of an attack. Further, breaches of safeguards within the security management instance can be identified and dealt with in real time to lock-down security management instance facilities before further progress is made in the attack and the protected assets compromised.

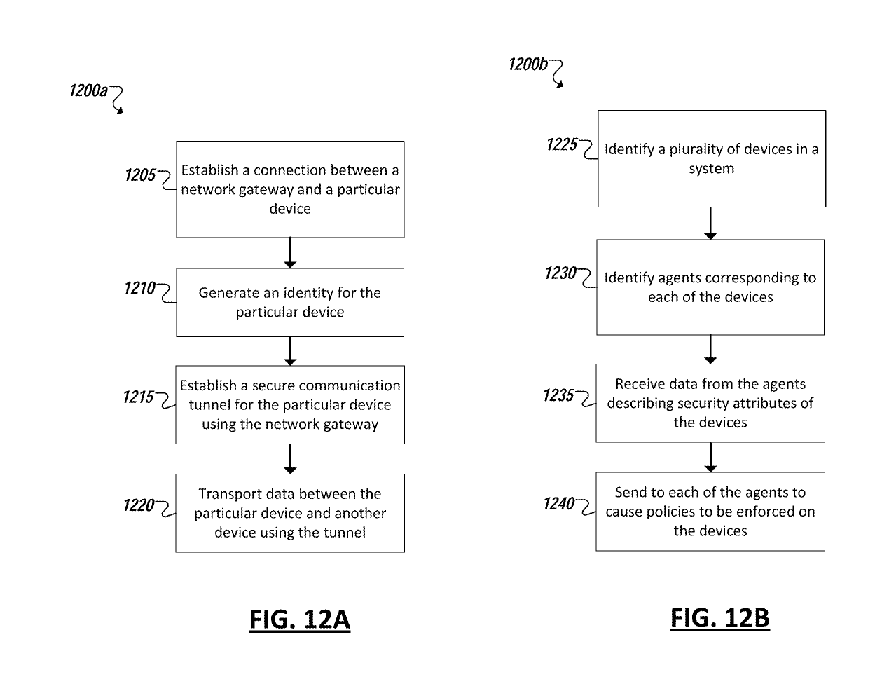

FIGS. 12A-12B are flow diagrams 1200a-b illustrating example techniques for providing network and computer security to assets in a system utilizing a separated security architecture. For instance, in FIG. 12A, a connection is established 1205 between a network gateway and a particular device connected to the network gateway (either by a wireline or wireless connection). The network gateway (e.g., using a security management instance on the network gateway) can generate an identity 1210 for the particular device for use in network connections between the particular device and other devices. Generation of the identity can include generating the identity using a secured hardware processor of the gateway device. Generation of the identity can also include generating a public key and/or other authentication data corresponding to the gateway device. A secure communication tunnel can be established 1215 by the gateway on behalf of the particular device. Establishing 1215 the secure communication tunnel can include performing a public key exchange with the other device on behalf of the particular device as well as negotiating a shared key for use in encrypting data on the tunnel. The secure communication tunnel can be established by the network gateway in response to an attempt by the particular device to initiate a connection or communication with the other device or an attempt by the other device to initiate communication with the particular device. The network gateway can also perform tasks to authenticate and authorize the other device. Authorization can be used to define what types of data and transactions involving the other device are to be permitted or blocked by the gateway on behalf of the particular device. The network gateway can coordinate the forwarding of data to and from the particular device over the secure communication tunnel (at 1220).

Turning to FIG. 12B, a plurality of devices (or “assets”) can be identified 1225 in a system, each having a respective operational context. The system itself can also have an operation context. Security management instances can be provided in the system to provide a security context for each of the devices. Agents can be identified 1230 that correspond to each of the devices. The agents can be implemented on the security management instances. Further, data can be received 1235 at a security management service from the agents describing security attributes detected by the security management instances. The backend security management service can analyze the data to determine security status of one or more of the devices. Further, the security management service can determine an update to a security policy to be applied to one of the devices based on the data received from the agents. These updates and other policy information can be sent 1240 to one or more of the agents to guide enforcement of security policies at the security management instances.

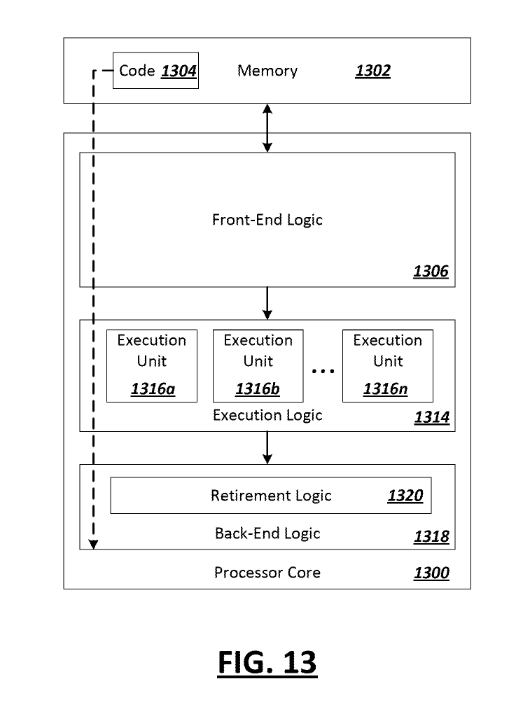

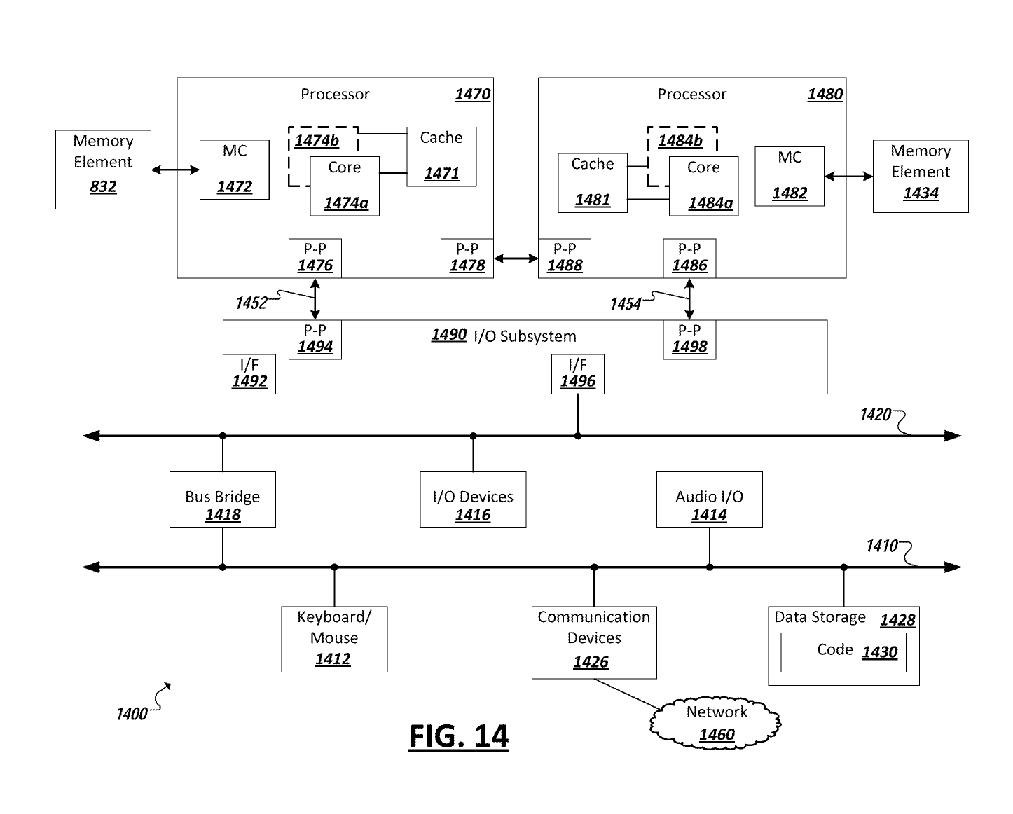

FIGS. 13-14 are block diagrams of exemplary computer architectures that may be used in accordance with embodiments disclosed herein. Other computer architecture designs known in the art for processors and computing systems may also be used. Generally, suitable computer architectures for embodiments disclosed herein can include, but are not limited to, configurations illustrated in FIGS. 13-14.

FIG. 13 is an example illustration of a processor according to an embodiment. Processor 1300 is an example of a type of hardware device that can be used in connection with the implementations above.

Processor 1300 may be any type of processor, such as a microprocessor, an embedded processor, a digital signal processor (DSP), a network processor, a multi-core processor, a single core processor, or other device to execute code. Although only one processor 1300 is illustrated in FIG. 13, a processing element may alternatively include more than one of processor 1300 illustrated in FIG. 13. Processor 1300 may be a single-threaded core or, for at least one embodiment, the processor 1300 may be multi-threaded in that it may include more than one hardware thread context (or “logical processor”) per core.

FIG. 13 also illustrates a memory 1302 coupled to processor 1300 in accordance with an embodiment. Memory 1302 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1300 can execute any type of instructions associated with algorithms, processes, or operations detailed herein. Generally, processor 1300 can transform an element or an article (e.g., data) from one state or thing to another state or thing.

Code 1304, which may be one or more instructions to be executed by processor 1300, may be stored in memory 1302, or may be stored in software, hardware, firmware, or any suitable combination thereof, or in any other internal or external component, device, element, or object where appropriate and based on particular needs. In one example, processor 1300 can follow a program sequence of instructions indicated by code 1304. Each instruction enters a front-end logic 1306 and is processed by one or more decoders 1308. The decoder may generate, as its output, a micro operation such as a fixed width micro operation in a predefined format, or may generate other instructions, microinstructions, or control signals that reflect the original code instruction. Front-end logic 1306 also includes register renaming logic 1310 and scheduling logic 1312, which generally allocate resources and queue the operation corresponding to the instruction for execution.

Processor 1300 can also include execution logic 1314 having a set of execution units 1316a, 1316b, 1316n, etc. Some embodiments may include a number of execution units dedicated to specific functions or sets of functions. Other embodiments may include only one execution unit or one execution unit that can perform a particular function. Execution logic 1314 performs the operations specified by code instructions.

After completion of execution of the operations specified by the code instructions, back-end logic 1318 can retire the instructions of code 1304. In one embodiment, processor 1300 allows out of order execution but requires in order retirement of instructions. Retirement logic 1320 may take a variety of known forms (e.g., re-order buffers or the like). In this manner, processor 1300 is transformed during execution of code 1304, at least in terms of the output generated by the decoder, hardware registers and tables utilized by register renaming logic 1310, and any registers (not shown) modified by execution logic 1314.

Although not shown in FIG. 13, a processing element may include other elements on a chip with processor 1300. For example, a processing element may include memory control logic along with processor 1300. The processing element may include I/O control logic and/or may include I/O control logic integrated with memory control logic. The processing element may also include one or more caches. In some embodiments, non-volatile memory (such as flash memory or fuses) may also be included on the chip with processor 1300.

FIG. 14 illustrates a computing system 1400 that is arranged in a point-to-point (PtP) configuration according to an embodiment. In particular, FIG. 14 shows a system where processors, memory, and input/output devices are interconnected by a number of point-to-point interfaces. Generally, one or more of the computing systems described herein may be configured in the same or similar manner as computing system 1400.

Processors 1470 and 1480 may also each include integrated memory controller logic (MC) 1472 and 1482 to communicate with memory elements 1432 and 1434. In alternative embodiments, memory controller logic 1472 and 1482 may be discreet logic separate from processors 1470 and 1480. Memory elements 1432 and/or 1434 may store various data to be used by processors 1470 and 1480 in achieving operations and functionality outlined herein.

Processors 1470 and 1480 may be any type of processor, such as those discussed in connection with other figures. Processors 1470 and 1480 may exchange data via a point-to-point (PtP) interface 1450 using point-to-point interface circuits 1478 and 1488, respectively. Processors 1470 and 1480 may each exchange data with a chipset 1490 via individual point-to-point interfaces 1452 and 1454 using point-to-point interface circuits 1476, 1486, 1494, and 1498. Chipset 1490 may also exchange data with a high-performance graphics circuit 1438 via a high-performance graphics interface 1439, using an interface circuit 1492, which could be a PtP interface circuit. In alternative embodiments, any or all of the PtP links illustrated in FIG. 14 could be implemented as a multi-drop bus rather than a PtP link.

Chipset 1490 may be in communication with a bus 1420 via an interface circuit 1496. Bus 1420 may have one or more devices that communicate over it, such as a bus bridge 1418 and I/O devices 1416. Via a bus 1410, bus bridge 1418 may be in communication with other devices such as a keyboard/mouse 1412 (or other input devices such as a touch screen, trackball, etc.), communication devices 1426 (such as modems, network interface devices, or other types of communication devices that may communicate through a computer network 1460), audio I/O devices 1414, and/or a data storage device 1428. Data storage device 1428 may store code 1430, which may be executed by processors 1470 and/or 1480. In alternative embodiments, any portions of the bus architectures could be implemented with one or more PtP links.

The computer system depicted in FIG. 14 is a schematic illustration of an embodiment of a computing system that may be utilized to implement various embodiments discussed herein. It will be appreciated that various components of the system depicted in FIG. 14 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

In general, one aspect of the subject matter described in this specification can be embodied in methods and executed instructions that include or cause the actions of identifying a plurality of devices in a system, where each device has an operational context, identifying, for each of the plurality of devices, one of a plurality of agents, which corresponds to the device, receiving data from the plurality of agents that describes security attributes of the plurality of devices, and sending policy data to each of the plurality of agents to cause a set of security policies to be applied to the plurality of devices through the security management instances. Each of the plurality of agents can be provided in a respective security management instance separate from the operational context.

These and other embodiments can each optionally include one or more of the following features. Other data can be received from another agent outside the plurality of agents that is deployed in a second system, and the other data can be used to provide security for the second system. The first system can have a first operational context and the second system can have a different, second operational context. The set of security policies can include a first set of security policies and the security for the second system is to be provided according to a different, second set of security policies. The plurality of agents can include at least one agent implemented on a security management instance of a network gateway and at least one agent implemented on a security management instance of a secured platform hosting an application. The security management instance of the network gateway can secure at least one particular device connected to the network gateway, for instance, by establishing a secure communication tunnel on behalf of the particular device and filtering communications between the particular device and other devices according to one or more of the set of security policies. The platform can include a hypervisor to host a virtualized instance of the application separate from the security management instance of the secured platform. The platform may also, or alternatively, include a processor device to support an encrypted execution mode, and processes of the security management instance can be executed in the encrypted execution mode.

These and other embodiments can each optionally include one or more of the following features. A plurality of defined trusted transaction spaces can be identified, a first plurality of devices included in a first one of the trusted transaction spaces and a second plurality of devices included in a second one of the trusted transaction spaces. A first one of the security policies can be enforced in communications between devices in the first trusted transaction space and a second one of the security policies can be enforced in communications between devices in the second trusted transaction space. Remote attestation can be performed, for instance, by receiving (e.g., at a backend security server) attestation data from a particular one of the agents corresponding to a particular one of the plurality of devices that describes one or more attributes of the particular device, and perform remote attestation of the particular device based on the attestation data.

In one or more examples, the set of policies can be updated based on one or more of the security attributes, one or more particular agents in the plurality of agents can be identified as affected by the update, and data can be sent to each of the particular agents to cause a different security policy to be applied to devices associated with the particular agents. At least a portion of the data can be exposed to a separate operational management service that manages the operational context of the system, such as data corresponding to a security event detected at one or more of the security management instances.

In at least some embodiments, a system can be provided that includes a first server device hosting a security management service, a second servicer device hosting an operational management service, and a plurality of assets, each asset associated with a corresponding security management instance that includes security logic to monitor corresponding assets and an agent to communicate securely with the security management service. The security management service can be separated from the operational management service, the security management service can manage a security context of the system, the operational management service can manage an operational context of the system, each of the assets can have a respective operational context, and the security management instance can provide a security context separate from the operational context of the corresponding asset.

In at least some examples, the security management service communicates with each of the agents over a respective secure communication tunnel. The system can further include at least one secured gateway device including a corresponding security management instance to provide secure network connections and monitor data on the secure network connections on behalf of one or more of the plurality of assets connected to the secured gateway device. Secure platforms can also, or alternatively, be provided that include a corresponding security management instance and a separated application instance hosting one or more software assets in the plurality of assets, where memory accesses and network communications involving the application instance are monitored by the security management instance. One or both of a secured gateway device and secured platform can include and utilize at least one hardware-based trusted execution environment.

In general, one aspect of the subject matter described in this specification can be embodied in methods and executed instructions that include or cause the actions of establishing a connection between a network gateway and a particular device, generating an identify for the particular device, and establishing a secure communication tunnel with another device at the network gateway. The secure communication tunnel can be established by the network gateway on behalf of the other device and is for use by the particular device to communicate with the other device. Data to be received from the other device over the secure communication tunnel can be sent on the connection to the particular device.

In at least some embodiments, authentication data can be generated for the particular device for use in establishing the secure communication tunnel. Establishing the secure communication tunnel can include mutual authentication of the particular device with the other device, and the network gateway is to perform the mutual authentication on behalf of the particular device. The authentication data ca be used in connection with a cryptographic algorithm used to secure the secure communication tunnel. The particular device can lack an operating system. The network gateway can include an agent to monitor data sent between the particular device and other device and report results of the monitoring to a backend security management server. A policy can be received from the backend security management server based on the results, and the policy can be applied to data to be sent between the particular device and other device. The agent can be provided in association with a security management instance on the network gateway that is to provide one or more security tools to secure at least the particular device and the network gateway. The agent can also monitor security of the security management instance. A secure communication tunnel can include a tunnel over a network, which utilizes a particular network protocol not supported by the particular device.

In at least some implementations, the other device can be authenticated to the particular device, at the network gateway, and authorization of the other device to transact with the particular device can be determined. Data can be monitored that is received at the network gateway and intended for the particular device. Results of the monitoring can be reported to a backend service using an out-of-band channel connecting the network gateway to a remote security management service. The out-of-band channel can include another secure communication tunnel. The particular device can be one of a plurality of devices connected to the network gateway and the network gateway can establish, on behalf of each of the plurality of devices, a respective secure communication tunnel.

In general, one aspect of the subject matter described in this specification can be embodied in methods and executed instructions that include or cause the actions of receiving data from an agent installed on a network gateway device that describes attributes of network security of one or more devices connected to the network gateway device, determining, from the received data, a security status of at least the particular device, and performing an action to apply a policy to one or more of the devices at the network gateway device based on the security status. The network gateway device can be provided to facilitate a secure connection (e.g., a secure tunnel) of at least a particular one of the one or more devices to a network.

In at least one example, second data can be received from another agent monitoring at least another device, and information in the first and second data can be correlated to determine a security status. A trusted transaction space can be defined to involve a subset of the one or more devices, where communications within the trusted transaction space are to be secured according to a particular one of a plurality of policies.

In some implementations, a system can be provided that includes a security manager, an endpoint device, and a gateway device connected to the gateway device. The gateway device can generate an identity for the endpoint device, establish a secure tunnel over a network between the endpoint device and another device on behalf of the endpoint device using the identity, monitor traffic between the endpoint device and the other device, and communicate data to the security manager over a secure out-of-band connection describing the traffic between the endpoint device and the other device. In at least on example the gateway instance includes a security management instance to provide one or more security tools for monitoring security at the gateway device and to include an agent to report results of the security tools to the security manager.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. At least one machine accessible storage medium having instructions stored thereon, the instructions when executed on a machine, cause the machine to:
identify a plurality of devices in a system, wherein each device has an operational context;
identify, for each of the plurality of devices, one of a plurality of agents, which corresponds to the device, wherein each of the plurality of agents is provided in a respective security management instance separate from the operational context;
receive data from the plurality of agents, wherein the data describes security attributes of the plurality of devices; and
send policy data to each of the plurality of agents to cause a set of security policies to be applied to the plurality of devices through the security management instances.

2. The storage medium of claim 1, wherein the system comprises a first system, and the instructions when executed, further cause the machine to:
receive other data from another agent outside the plurality of agents, wherein the other agent is deployed in a second system; and
use the other data to provide security for the second system.

3. The storage medium of claim 2, wherein the first system has a first operational context and the second system has a different, second operational context.

4. The storage medium of claim 2, wherein the set of security policies comprises a first set of security policies and the security for the second system is to be provided according to a different, second set of security policies.

5. The storage medium of claim 1, wherein the plurality of agents comprises at least one agent implemented on a security management instance of a network gateway and at least one agent implemented on a security management instance of a secured platform hosting an application.

6. The storage medium of claim 5, wherein the security management instance of the network gateway is to secure at least one particular device connected to the network gateway.

7. The storage medium of claim 6, wherein the security management instance of the network gateway is to establish a secure communication tunnel on behalf of the particular device and filter communications between the particular device and other devices according to one or more of the set of security policies.

8. The storage medium of claim 5, wherein the platform comprises a hypervisor to host a virtualized instance of the application separate from the security management instance of the secured platform.

9. The storage medium of claim 5, wherein the platform comprises a processor device to support an encrypted execution mode, and processes of the security management instance are to be executed in the encrypted execution mode.

10. The storage medium of claim 1, wherein instructions when executed on a machine, further cause the machine to:
identify a plurality of defined trusted transaction spaces, wherein a first plurality of devices are to be included in a first one of the trusted transaction spaces and a second plurality of devices are to be included in a second one of the trusted transaction spaces;
cause a first one of the security policies to be enforced in communications between devices in the first trusted transaction space; and
cause a second one of the security policies to be enforced in communications between devices in the second trusted transaction space.

11. The storage medium of claim 1, wherein instructions when executed on a machine, further cause the machine to:
receive attestation data from a particular one of the agents corresponding to a particular one of the plurality of devices, wherein the attestation data describes one or more attributes of the particular device; and
perform remote attestation of the particular device based on the attestation data.

12. The storage medium of claim 1, wherein instructions when executed on a machine, further cause the machine to:
update the set of policies based on one or more of the security attributes;
identify one or more particular agents in the plurality of agents affected by the update; and
send data to each of the particular agents to cause a different security policy to be applied to devices associated with the particular agents.

13. The storage medium of claim 1, wherein instructions when executed on a machine, further cause the machine to expose at least a portion of the data to an operational management service, wherein the operational management service manages the operational context of the system.

14. The storage medium of claim 13, wherein the portion of the data corresponds to a security event detected at one or more of the security management instances.

15. A method comprising:
identifying a plurality of devices in a system, wherein each device has an operational context;
identifying, for each of the plurality of devices, one of a plurality of agents that corresponds to the device, wherein each of the plurality of agents is provided in a respective security management instance separate from the operational context;
receiving data from the plurality of agents, wherein the data describes security attributes of the plurality of devices;
sending data to each of the plurality of agents to cause a set of security policies to be applied to the plurality of devices through the security management instances.

16. A system comprising:
a first server device hosting a security management service;
a second servicer device hosting an operational management service; and
a plurality of assets, each asset associated with a corresponding security management instance and each security management instance comprises security logic to monitor corresponding assets and an agent to communicate securely with the security management service,
wherein the security management service is separated from the operational management service, the security management service manages a security context of the system, the operational management service manages an operational context of the system, each of the assets has a respective operational context and the security management instance provides a security context separate from the operational context of the corresponding asset.

17. The system of claim 16, wherein the security management service communicates with each of the agents over a respective secure communication tunnel.

18. The system of claim 16, further comprising at least one secured gateway device comprising a corresponding security management instance, wherein the security management instance of the secured gateway device is to provide secure network connections and monitor data on the secure network connections on behalf of one or more of the plurality of assets connected to the secured gateway device.

19. The system of claim 18, further comprising at least one secured platform comprising a corresponding security management instance and a separated application instance hosting one or more software assets in the plurality of assets, wherein memory accesses and network communications involving the application instance are monitored by the security management instance.

20. The system of claim 19, wherein each of the secured gateway device and secured platform further comprise at least one hardware-based trusted execution environment.
